(19) United States
(12) Patent Application Publication
(10) Pub. No.: US 2014/0253913 A1
(43) Pub. Date: Sep. 11, 2014

(54) Optical Systems For Measuring A Drilled Hole In A Structure And Methods Relating Thereto

(71) Applicant: UNITED SCIENCES, LLC, Atlanta, GA (US)

(72) Inventors: HARRIS BERGMAN, ATLANTA, GA (US); HENRIK ISKOV CHRISTENSEN, ATLANTA, GA (US); KAROL HATZILIAS, ATLANTA, GA (US)

(73) Assignee: UNITED SCIENCES, LLC, Atlanta, GA (US)

(21) Appl. No.: 14/283,533

(22) Filed: May 21, 2014

Related U.S. Application Data
(63) Continuation-in-part of application No. 13/767,017, filed on Feb. 14, 2013.
(60) Provisional application No. 61/871,002, filed on Aug. 28, 2013.

(51) Int. Cl. G01N 21/954

(52) U.S. Cl. CPC G01N 21/954; G01N 2021/9542
USPC 356/241.1

(57) ABSTRACT

A system for measuring a drilled hole in a structure, the drilled hole having a drilled hole wall, includes a probe having a probe body movable along a probe path extending into the drilled hole, the probe body supporting an optical illumination path and an optical section signal path. Illumination follows the illumination path and is emitted radially outwardly from the probe body so as to illuminate the drilled hole wall when the probe body is disposed at a location along the probe path and the illumination is transmitted along the illumination path. Illumination reflecting from the drilled hole wall back toward an optical sensor represents an optical section signal associated with the location of the probe along the probe path.

### CROSS-REFERENCE TO RELATED APPLICATION

The present application is a continuation-in-part of U.S. patent application Ser. No. 13/767,017, filed Feb. 14, 2013, currently pending, the disclosure of which is incorporated by reference herein in its entirety for all purposes.

### FIELD OF THE INVENTION

The present invention relates to optical systems and methods for measuring and evaluating an interior surface of a cavity, and more particularly to scanning and evaluating a drilled hole in a structure.

### BACKGROUND

Many industries, and in particular the aerospace industry and more particularly the commercial aircraft manufacturing industry, require the drilling of millions of precisely located holes to precise specifications. In many instances these holes are drilled by robotic systems that include drilling end effectors. After a group of holes has been drilled, the drilled holes are inspected to ensure that they are within tolerance. The inspection involves checking the diameter and circularity of each hole at different depths to ensure that each hole is straight and not elliptical, conical, hourglass-shaped, etc. Such inspections are performed by human quality assurance inspectors, who inspect, in an extremely laborious process, large groups of holes at one time. A quality insurance inspector may also be able to identify a damaged drill bit by, for example, identifying a large number of out-of-tolerance holes. Unfortunately, however, by the time the inspector identifies the damaged drill bit hundreds or even thousands of holes may have been drilled with that drill bit and may be out of tolerance. While an out of tolerance hole may perhaps be corrected by re-drilling the hole at a higher bore size, there are limits to the number of times a hole can be re-drilled.

Prior art attempts to evaluate drill holes include focal microscopy for fringe pattern analysis, i.e., image analysis. The pattern is compared with a pre-image of a correctly drilled hole. Such methods, however, are difficult to deploy and not particularly accurate. One known hole measurement apparatus is a capacitive probe. Such probes, however, take measurements in only one direction at a time, requiring multiple measurements to assess a hole. In addition, these capacitive probes are incapable of assembling a complete image of the inside of a drilled hole. Further, a capacitive probe must fit tightly into a drilled hole, be aligned closely to the center axis of the hole, and, for calibration purposes, must have the same probe-to-hole-side separation at all times (because its capacitance is calibrated according to the thickness of the layer of air between the probe and the wall of the hole). When such a capacitive probe identifies an out-of-tolerance hole, and the hole is re-drilled to a larger diameter, the capacitive probe must be replaced with a larger diameter probe to allow for re-measurement of the re-drilled hole.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

The presently described systems and methods for measuring one or more drilled holes provide a systematic means to evaluate the configuration of each hole with speed and precision not currently available in the art. Thus, an optical system as provided herein measures one or more drilled holes in a structure, the one or more drilled holes each having a drilled hole wall. The optical system includes a probe having a probe body movable along a probe path extending into the drilled hole. The probe body houses an illumination source that directs illumination (which may be visible or invisible light) along an illumination path such that the illumination is emitted radially outwardly from the probe body. The illumination emitted from the probe will illuminate the drilled hole wall when the probe body is disposed at a location along the probe path.

Some of the illumination will be reflected from the drilled hole wall towards an optical sensor housed in the probe. Such reflected illumination is referred to herein as an “optical section signal” because, when received by the optical sensor and processed, it will be indicative of a two-dimensional cross-sectional shape of the drilled hole transverse to the probe body. The optical path from the drilled hole wall to the optical sensor is referred to herein as the optical section signal path of the probe.

A plurality of optical section signals reflected from a plurality of points along the probe path may be received by the optical sensor and processed to determine attributes of the drilled hole. By way of example, a drilled hole may include a countersunk shape and its attributes may be indicative of the countersunk shape. The attributes of the drilled hole can be used in a variety of methods, including methods to determine whether the hole is out of tolerance and/or should be re-drilled, to determine whether the drill that drilled the hole is damaged, and to predict whether the hole is and/or other holes are likely to go out of tolerance in the future.

The system optionally includes a robot to improve speed and repeatability of analyzing the one or more drilled holes. A robot included with the optical system movably supports the probe and provides signals indicative of the location of the probe along the probe path. The robot may comprise a probe deployment system such that the probe is moved from one drilled hole to another and to locations along the probe path.

The system can further comprise at least one processor that executes program code for processing data signals output by the optical sensor to determine attributes of the drilled hole. The processor may be communicatively coupled to the optical sensor and the robot for receiving data signals from the optical sensor and signals representing the associated locations of the probe from the robot. The processor may further be communicatively coupled to a memory storage device for storing attributes of drilled holes.

The optical sensor of the system is configured to generate two-dimensional hole section data when the probe is disposed at a location along the probe path and while the robot moves the probe continuously between first and second locations along the probe path. The optical sensor may comprise a detector, camera, and/or sensors based on CCD, CMOS or CID technology.

In certain embodiments, the optical probe may form a part of a hand-held system, wherein the hand-held system is configured to associate attributes of the drilled hole determined from optical section signals with hole identification data indicative of a hole location on the structure. A tripod, clamp, adaptor plate, suction cup, or guide may be coupled to the hand-held system to align the probe relative to the drilled hole.

The illumination source of the system may include at least one laser or light emitting diode. The probe body has a proximal end and a distal end and the distal end is extendable into the drilled hole. The illumination source may be coupled to or otherwise positioned in the distal end of the probe body, while the optical sensor is coupled to or otherwise positioned in the proximal end of the probe body. Alternatively, the illumination source and optical sensor may both be coupled to or otherwise positioned in the proximal or distal end of the probe body. The illumination source may be aligned with the probe body so as to direct illumination substantially parallel to a probe axis, or the illumination source may be aligned with the probe body so as to direct illumination substantially perpendicular or at an angle to a probe axis. The pattern of illumination emitted from the probe may be planar or conical. In one embodiment, the illumination path is defined in-part by an optical element, such as a reflective element or a lens.

The optical section signal path may similarly be defined in-part by an optical element, such as a lens or reflective element, configured to direct optical section signals toward the optical sensor. The optical section signal path is thus configured such that the optical sensor can image a cross section of the drilled hole associated with the location of the probe along the probe path. The illumination path and the optical section signal path may each be defined in-part by the same optical element. Alternatively, the illumination path may be defined in-part by a second optical element offset from the first optical element. At least one of the optical elements may include a conical surface. At least one of the optical elements may include a lens assembly including a plurality of lenses.

In some embodiments, at least one mask element may be arranged on or around the optical elements used to define the illumination path and/or optical section signal path so as to block unwanted reflections and thereby mitigate noise. Additionally or alternatively, the probe body may include an anti-reflective surface coating or anti-reflective surface configured to mitigate noise.

A method for using an optical scanning system for measuring a drilled hole in a structure having a drilled hole wall includes emitting illumination radially from a probe along an illumination path, where the probe is moveable along a probe path extending into the drilled hole. The emitted illumination illuminates the drilled hole wall and a portion of such illumination is reflected there from and directed to an optical sensor. The illumination detected by the optical sensor (i.e., the optical section signal) can be processed to determine a two-dimensional cross section of the drilled hole wall associated with a location of the probe along the probe path. Two-dimensional cross sections may be determined along the probe path so as to determine attributes of the drilled hole.

The method may further include moving the probe continuously between first and second locations along the probe path and providing signals indicative of the location of the probe along the probe path. The attributes of the drilled hole may further be associated with hole identification data indicative of a hole location on the structure. The illumination emitted by the illumination source maybe collimated or semi-collimated visible or invisible light.

### BRIEF DESCRIPTION OF THE DRAWINGS

Illustrative embodiments of the present invention are described in detail below with reference to the following drawing figures:

FIG. 1 is a block diagram showing basic functionality of an optical system according to an exemplary embodiment of the present invention.

FIG. 2 is a drawing of exemplary apparatus for the optical measurement of drilled holes.

FIG. 3 is a drawing of exemplary optical probe for the measurement of drilled holes.

FIG. 4 is a drawing of further examples of apparatus for the optical measurement of drilled holes.

FIG. 5 is a schematized drawing, partly in section, of an exemplary apparatus for the optical measurement of drilled holes.

FIGS. 6-12 are illustrations of various optical probe embodiments of the present invention.

FIG. 6 illustrates an optical probe supporting an optical illumination path defined in-part by an optical element having a conical surface.

FIG. 7 illustrates an optical probe including a plurality of optical illumination sources.

FIG. 8 illustrates an optical probe supporting an optical illumination path defined in-part by an optical element having a first conical surface and an optical sensing path defined in-part by a second conical surface offset from the first conical surface.

FIG. 9 illustrates an optical probe having an optical illumination source on the same side of the probe as the optical sensor and aligned parallel to the optical sensor and an optical illumination path and optical sensing path defined in-part by an optical element having a conical surface.

FIGS. 10 and 11 illustrate optical probes having offset optical illumination sources.

FIG. 10 illustrates an optical probe having an optical illumination source on the same side of the probe as the optical sensor and aligned perpendicular to the optical sensor and an optical illumination path and optical sensing path defined in-part by an optical element having a conical surface.

FIG. 11 illustrates an optical probe having an optical illumination source on the same side of the probe as the optical sensor and aligned at a non-perpendicular angle to the optical sensor and an optical illumination path and optical sensing path defined in-part by an optical element having a conical surface.

FIG. 12 illustrates an optical probe for identifying attributes of a structure surface exterior to a drilled hole.

FIG. 13 is an illustration of a hand-held system having an optical probe according to yet another embodiment of the present invention.

FIG. 14 sets forth a line drawing of a further exemplary apparatus for the optical measurement of drilled holes.

FIG. 15 is a schematic diagram of an optical scanning system according to another embodiment of the present invention.

FIGS. 16A and 16B are illustrations of an end effector according to an embodiment of the present invention.

FIGS. 17A and 17B are illustrations of an optical probe deployment system according to an embodiment of the present invention.

FIG. 18 is an isometric view of a control box according to an embodiment of the present invention.

FIGS. 19A and 19B are block diagrams of further methods of using the optical scanning system of the present invention.

FIG. 20 is a flow chart illustrating an exemplary method for measuring a drilled hole.

FIGS. 21 and 22 are block diagrams of methods for identifying damage of a drill using the optical probe of the present invention.

FIGS. 23A and 23B are block diagrams of a method for profiling a drilled hole over a period of time during aircraft maintenance operations.

FIG. 24 is a block diagram of a method for profiling a drilled hole over a period of time using the optical probe of the present invention.

FIG. 25 is a block diagram of a method for inspecting a drilled hole.

FIG. 26 is a block diagram of another method for inspecting a drilled hole.

FIG. 27 is a block diagram illustrating an exemplary profile for a drilled hole.

### DETAILED DESCRIPTION

The subject matter of embodiments of the present invention is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

### Optical Systems

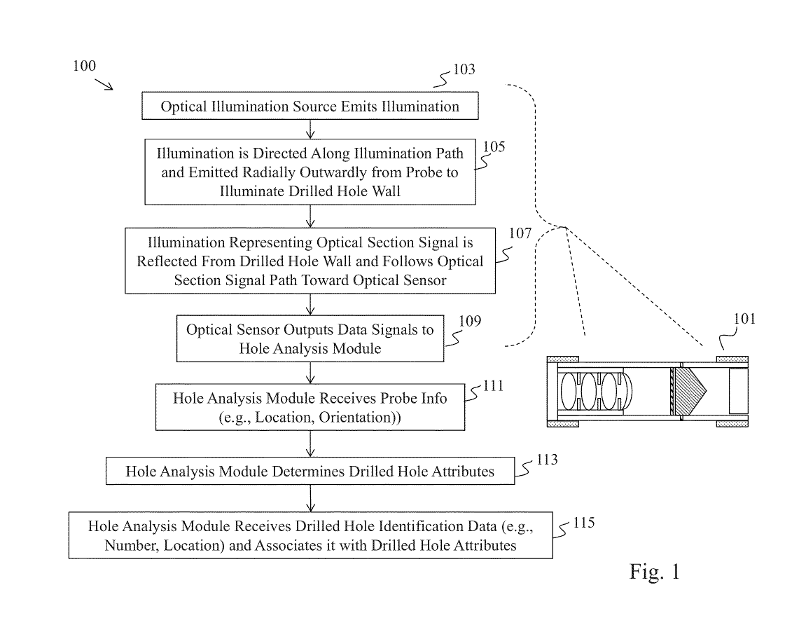

An optical system for measuring drilled holes and methods of using the system provide precision and speed in the analysis of the integrity and specific configuration of the drilled holes. FIG. 1 is a block diagram illustrating the basic functionality of within an exemplary optical system 100 for measuring a drilled hole in a structure according to embodiments of the present invention. As shown, the optical system 100 may utilize an optical probe 101 and associated systems according to embodiments described below. The optical probe 101 includes components (some of which are not shown) that generate light, that direct light along desired paths to and/or from the drilled hole wall, and/or that measure light reflected from the drilled hole wall. Note that some these components can be used for more than one of these functions, such as by using a mirror or lens both to direct light to and from the drilled hole wall.

In particular, the optical probe 101 includes an optical probe body which houses an illumination source. As shown by block 103, the illumination source is configured to emit illumination. As shown by block 105, the illumination emitted by the illumination source is directed along an illumination path that extends radially outwardly from the optical probe 101. The optical probe body may also house an arrangement of one or more physical components which define, at least in part, the illumination path. In particular, the illumination path begins at the illumination source and may be deflected, reflected and/or refracted by one or more intervening elements (e.g., mirrors, lenses, prisms, and/or optical fibers, etc.) toward the surface of the drilled hole wall. Thus, illumination travels from the illumination source along the optical illumination path and is emitted radially outwardly from the probe body so as to illuminate the surface of the drilled hole wall. As described below with respect to various embodiments, in three dimensional space the pattern of illumination emitted from the probe body will be planar when the illumination extends perpendicularly from the probe body, and it will be conical when the illumination extends at a non-perpendicular angle from the probe body. Still other illumination patterns may be provided in other embodiments. For example, with the illumination emitted from the probe body may be helical in shape, and the like.

Some of the illumination emitted from the probe body and reflected from the drilled hole wall will be directed toward an optical sensor, as shown by block 107. This reflected illumination is referred to herein an “optical section signal” because, when received by the optical sensor and subsequently processed, it can be used to determine a two-dimensional cross-sectional shape of the drilled hole wall transverse to the probe body. The optical path from the drilled hole wall to the optical sensor is referred to herein as the “optical section signal path”. Exemplary optical sensor embodiments are described in more detail below.

The optical sensor outputs data signals to a hole analysis module as shown in block 109. The hole analysis module may be executed by a local processor included in the optical probe 101 or by a remote computing device connected to the probe 101 via a wired or wireless network. The hole analysis module processes the sensor data signals to determine the two-dimensional cross-sectional shape of the drilled hole wall associated with the location of the probe. As the optical probe 101 moves along a probe path extending into the drilled hole, the hole analysis module receives additional sensor data signals and processes them to determine additional two-dimensional cross-sectional shapes of the drilled hole wall at different points along the probe path. The hole analysis module (or another program module) also receives probe information (e.g., the location of the probe relative to the probe path and the orientation of the probe relative the probe path) associated with the sensor signals representing each optical section signal, as shown by block 111. As discussed herein, the probe information may be obtained from robotic or optical probe deployment systems. At block 113, the hole analysis module utilizes these inputs from the optical sensor and associated locations of the probe information to determine attributes of the drilled hole. As shown by block 115, attributes of the drilled hole may be associated with hole identification data relating to the drilled hole itself (e.g., the location and/or identification number for the drilled hole on the structure).

Common attributes of the drilled hole that could be determined by the hole analysis module include hole diameter and circularity. One of skill in the art will recognize that not all drilled holes are the same and that the diameter to length ratio varies according to the purpose of the specific hole. The tolerance for variation also varies given the purpose of a drilled hole. However, the present systems provide a means to identify variations to determine whether the variations are within tolerance range. The system can determine other attributes including, but not limited to, bore diameter, surface finish, elongation, smoothness, depth, surface roughness, cracking, burr identification, pit identification, straightness, planarity, circularity, cylindricity, line profile (e.g., angular position of the hole axis with regard to the surface), surface profile (e.g., peak-to-valley surface profiles), perpendicularity (e.g., of the side walls to the bottom surface), angularity, parallelism (e.g., on opposite sides of the hole), symmetry, positional tolerance (e.g., tolerance in the location of the hole and alignment of the hole center point, center axis, or center of a plane), concentricity (i.e., commonality of an axis), circular runout (e.g., variation across the surface at one or more cross-sectional areas), total runout (e.g., variations across the entire surface of the hole), layer inspection, and countersink properties including taper angle, taper depth and counterbore properties. Additional attributes that may be determined for composite surfaces include, but are not limited to, microbuckling (e.g., a localized band of buckled composite fibers), waves, fish eyes (e.g., a defect with a center pore and radial fractures from the pore), delamination, gaps, cracks, lanes/suspensions, improper manufacturing techniques, disbond, and porosity.

The exemplary optical system 100 can also determine attributes external to a drilled hole, for example burrs or pits at or near a surface near the opening of the drilled hole. Furthermore, the system can be used to detect the position (e.g., the angle of an axis) of the hole with regard to the surface at the opening.

Optical probe systems described herein are suitable for identifying attributes of a wide range of drilled holes and to a high level of precision. Purely by way of example, optical probe embodiments described herein can profile and identify attributes of drilled holes having diameters of from about 3/16″ to ½″. The optical probe systems describe herein can measure diameter to within ±0.0003″ when standardized to a set ring which is certified to +/−0.00005″. Maximum and minimum diameter values are compared to upper and lower control limits. Countersink depths of drilled holes may range from about 0.080″ to 0.250″, have angles of about 82° to 100°, and be measured to an accuracy of ±0.0005″. Material stack thickness may vary from about 0.25″ to 2.00″ and may be measured to an accuracy of ±0.005″. The systems described herein can profile and determine attributes of holes drilled in composite, laminate and other mixed material surfaces, including those having any combination of carbon, aluminum, and titanium layers. It will be appreciated that the systems described herein would be suitable to profile and determine attributes of drilled holes having other dimensions and to other degrees of accuracy.

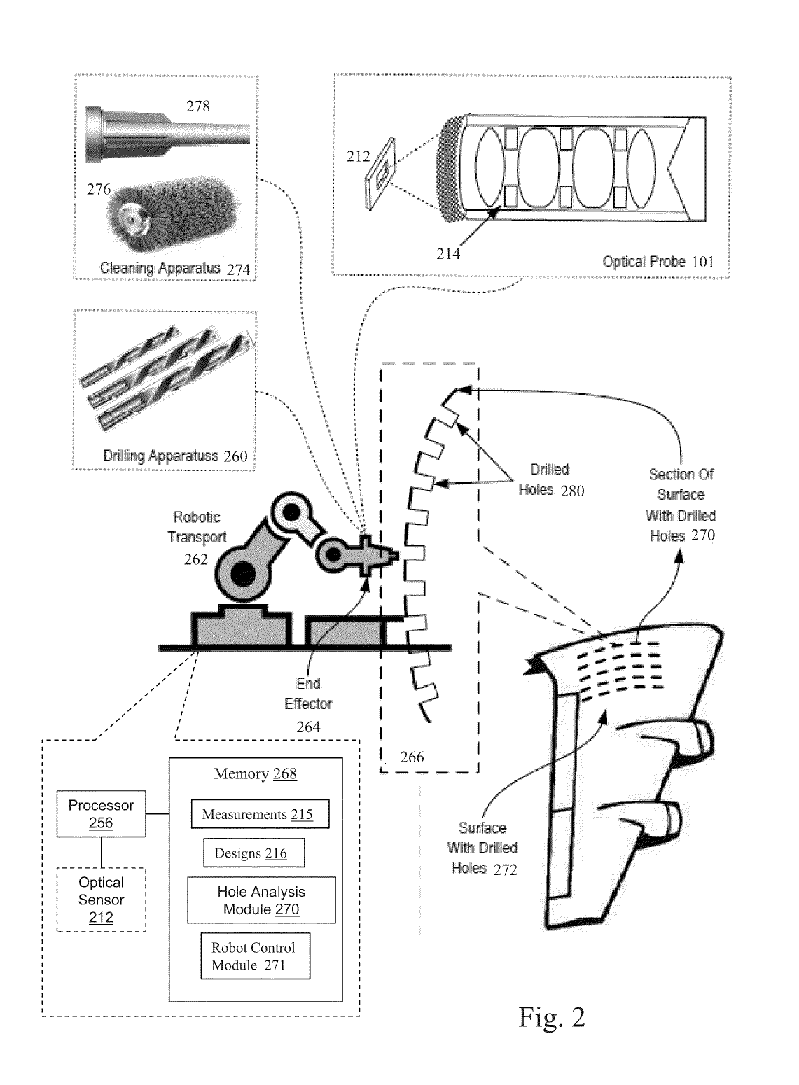

Various embodiments of an exemplary optical system 100, its operation, and methods of use are described with reference to FIGS. 2-15. FIG. 2 depicts an exemplary apparatus and methods for optical measurement of drilled holes. The apparatus of FIG. 2 includes an optical probe 101 and a robotic transport 262. The robotic transport 262, which may comprise a probe deployment system, is adapted to the optical probe 101 so as to continuously move the optical probe 101 inside a drilled hole 280 to measure the drilled hole at different depths. Embodiments for the optical probe 101 and robotic transport 262 are described in more detail with reference to the additional figures as described below.

In this example, the robotic transport 262 is adapted to the optical probe 101 by mounting the optical probe 101 on an end effector 164 of the robotic transport 262. The optical probe 101 may be mounted in a fixed position on the end effector 264, with drilling apparatus 260 also mounted in a fixed position on the end effector 264 so that positioning the optical probe 101 at a drilled hole 280 after drilling requires repositioning of the robotic transport 262. Alternatively, both drilling apparatus 260 and the probe 101 may be rotatably mounted on the end effector 264 with separate home positions and the same deployed position, so that, after drilling, the drilling apparatus 260 is rotated to its home position and the optical probe 101 is rotated into its deployed position to measure a drilled hole 280. As a further alternative, the optical probe 101 may be the only operable device on the end effector 264, so that a drilling apparatus 260 is mounted on an entirely separate transport, and the optical probe 101 follows along and measures a drilled hole 280 after the drill has drilled the hole and moved to a next location to drill a next hole.

Because some materials have optical properties that do not lend themselves well to optical measurement, an opacifying material may be blown onto the drilled hole prior to measuring it and after the drilled hole has been cleaned. An example of an opacifier is talc or silicone powder. The material has the property of reflecting the ring of light in a predictable manner and it has a small and uniform particle size. After the hole is measured, the opacifying material may be removed (e.g., by vacuum) so that the hole is free of the material.

In the example of FIG. 2, the optical probe 101 projects rings of light to illuminate the inside of a drilled hole 280, and an optical sensor 212 receives illumination (i.e. an optical section signal) that is reflected from the inside of the drilled hole 280 and directed to the optical sensor 212 through an optical element, such as lens 214. As explained in further detail below, a processor 256 executes programming logic, which may be embodied as a hole analysis module 270 and/or another program module, for determining from data signals received from the optical sensor 112, the measurements 215 of the drilled hole 280. For example, the programming logic determines by comparison of design measurements 216 and the measurements 215 of the drilled hole 280 whether the hole as drilled is within design tolerance. The measurements so compared typically include hole diameter and hole circularity and can include measurements related to various other attributes as described herein. The program logic also infers from disparities among pixel values in the measurements 215 whether a crack may be present in a wall of a drilled hole 280. Thus, the processor 256 can determine numerous attributes.

In the example of FIG. 2, the processor 256 also determines, by comparison of design measurements 216 and the measurements 215 of the drilled hole, whether the hole as drilled fails to meet design tolerance. If a hole so fails, the hole analysis module 270 can alert the robot control module 216, which can instruct the drilling apparatus 260 to redrill the hole at a larger diameter, and the robotic transport 262 is further so adapted to the optical probe 101 as to continuously move the optical probe 101 inside the redrilled hole to remeasure the drilled hole 280 at different depths with the same optical probe 101. The robot control module 216 may be configured to instruct the redrilling and remeasuring processes to occur continuously and without interruption, improving the efficiency of the system. Optionally, the robot control module 216 can signal the user of the failure to meet the predetermined tolerance level.

Also in the example of FIG. 2, the end effector 264 carries a cleaning apparatus 274 that includes a compressed air nozzle 278 and an industrial wire or non-wire brush 276 both of which are adapted to the end effector 264 so as to facilitate cleaning both a drilled hole 280 before scanning the hole with the optical probe 101 and also to clean the optical probe 101 itself. Alternatively or additionally, the end effector 264 may implement a reamer or vacuum to smooth or clean the drilled hole 280. As with the drilling apparatus 260, the cleaning apparatus 274 may reside on the same robotic transport 262 or on an entirely different robotic transport and may be rotated or translated into position with respect to a drilled hole 280.

In the example of FIG. 2, the surface 272 with drilled holes 280 is illustrated as a wing of an aircraft with a callout 266 illustrating a section 270 of the surface with the drilled holes 280. However, apparatuses for optical measurement of drilled holes 280 may be used for optical measurement of drilled holes 280 on many surfaces, including, by way of example, automotive surfaces, surfaces of naval vessels, aerospace vehicle surfaces, windmill surfaces, nuclear energy equipment surfaces, non-nuclear power sources and so on.

In addition, the drilled holes 280 in the example of FIG. 2 are illustrated as countersunk with a single diameter in a single material, but measurement of drilled holes may also be done with respect to through-holes, holes with variable diameters, holes through a variety of construction materials, including, for example, aluminum, steel, titanium, plastic, composites, and so on.

The apparatus of FIG. 2 can be used to produce a profile, e.g., data points or a 3D reconstruction of a drilled hole for viewing by an operator. The profile includes all or a portion of the data collected with respect to a specific hole. The 3D reconstruction is generated by registering by the hole analysis module 270 in memory 268 all of the cross-section measurement data (i.e., derived from optical section signals) into a three-dimensional point cloud or mesh. The optical section signals provide data read, for example, from the illuminated inside surface of the drilled hole. The relative position and/or orientation of the optical section signals is determined by the speed of the robotic transport's 262 movement of the optical probe 101 within a drilled hole 280 as set configured by the robot control module 216 and the frame rate of the optical sensor 212. The data profile (e.g., the 3D reconstruction) can be rendered on a display such as a graphical user interface.

Alternatively, or additionally, the hole analysis module 270 stores the three-dimensional profile data or other attributes for the drilled hole 280 (described above) in memory 268 for further use, optionally with data from other drilled holes 280 or with data for the same hole over time as a database. Thus, the profile and attribute data are useful in tracking changes to the drilled hole 280 over time, determining whether the drilled hole 280 is or may go out of tolerance in the future, and determining whether the drilling apparatus 260 used to drill the drilled hole 280 is damaged. Data collected over time in the database provides both historical comparisons as well as predictive value for the same or different drilled holes 280.

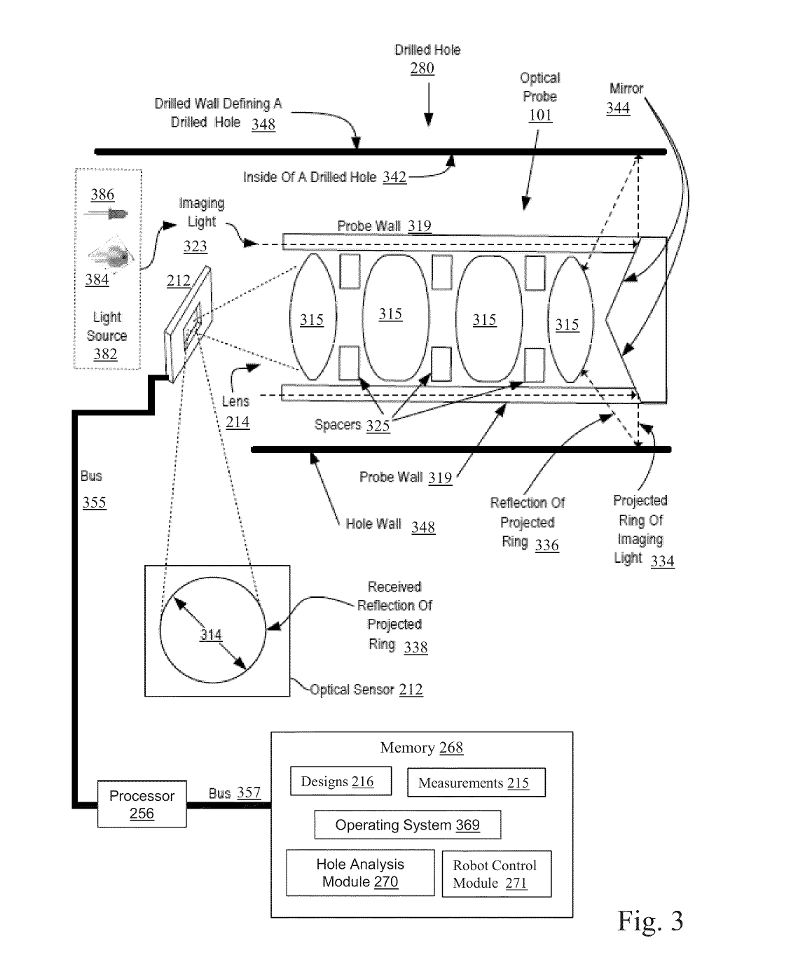

FIG. 3 is a drawing of an exemplary optical probe 101 for measurement of a drilled hole. The drilled hole 280 in this example has a wall 348 defining the drilled hole 280 and defining the inside 342 of the drilled hole 280. The optical probe 101 includes a tubular or cylindrical probe wall 319 and a lens 214 disposed within and supported by the probe wall 319. The lens 214 of FIG. 3 is composed of lens elements 315 that are separated by spacers 325. The optical probe 101 of FIG. 3 also has an illumination source, such as a light source 382 that produces imaging light 323 (also referred to as illumination) that is carried between the probe wall 319 and optical elements, in this case a mirror 344 to the lens 214, in an optical illumination path. The imaging light may be carried from the light source 382 to the mirror 344 by use of glass, fiber, or optic cables, or in other ways. In the example of FIG. 3, imaging light 323 is conducted from a light source 382 through the tubular probe wall 319 to the mirror 344, which projects a ring 334 of imaging light 323 on the inside surface 342 of the drilled hole 280. In this example, the tubular probe wall 319 is composed of a transparent, light-conducting optical material such as, for example, optical glass or quartz crystal.

FIG. 3 illustrates two exemplary light sources 382, a light emitting diode (‘LED’) 386 and a laser diode 384, both useful in optical measurement of drilled holes. A laser emits a single wavelength of coherent light. An LED emits a small range or bandwidth of wavelengths, incoherent, but collimated in its passage through the optical probe wall. There is no limitation to any particular wavelength or number of light sources; several may be used because different wavelengths may better illuminate various materials in which holes are drilled. The illustration of LED 386 and laser diode 384 in the example of FIG. 3 is for explanation and not for limitation. Many sources of light may be useful in optical measurement of drilled holes, including even sources of white light, for example, that is useful for illuminating a hole for visual or video inspection. Those skilled in the art will recognize that various different wavelengths of visible and nonvisible light, corresponding to the detection capability of the optical sensor 212, may be used in connection different with the present invention.

In the example of FIG. 3, the light source 382 and the mirror 344 of the optical probe 101 projects at least one ring 134 of light on the inside 342 of the drilled hole 280 as the optical probe 101 is moved into or out of the drilled hole 280. Reflections of projected rings 336 reflect from the inside 342 of the drilled hole 280 and are directed toward an optical sensor 212 through an optical lens 214 and/or other optical element(s) of the optical probe 101. The optical sensor 212 detects the received reflections of projected rings 338. The optical sensor 212 may be implemented as a charged coupled device (‘CCD’), as a complementary metal oxide semiconductor (‘CMOS’) sensor, as a charge injection device (‘CID’) and in other ways as will occur to those of skill in the art.

As shown in the example of FIG. 3, the optical probe 101 includes a processor 256, coupled to the optical sensor 212 and the memory 268. For example, the processor 256 may be coupled to the optical sensor 212 through a data bus 355 and may be coupled to the memory 268 through a memory bus 357. In other embodiments, some or all components of the optical probe 101 may be coupled to and interact with each other by way of a common system bus. A number of program modules comprising computer executable instructions may be stored in the memory 268 and/or any other internal, removable and/or remote computer-readable media associated with the optical probe 101.

For example, the program modules may include an operating system 369. Aspects of the exemplary embodiments of the invention may be embodied in one or more hole analysis module(s) 270 (and/or other program modules) for controlling the operation of the light source 382 and the optical sensor 212 and for determining optical measurement of drilled holes 280 according to the various embodiments described herein. For example, the hole analysis program module(s) 270 may include programming logic for determining, from received reflections of projected rings 338, measurements 215 of a drilled hole 280. Measurements 215 of a drilled hole typically include drilled hole diameter, hole circularity, inferences whether a crack may be present in a hole wall, and numerous other attributes such as those described herein. Furthermore, designs 216, measurements 215 and other data accessed, used and stored by the hole analysis module(s) 270, as well as other data used by the optical probe 101, may be stored in the memory 268 or in/on any other computer-readable medium associated with the optical probe 106.

The processor 256 may be implemented as a Harvard architecture microcontroller with a control program in memory 268, a generally programmable Von Neumann architecture microprocessor with a control program in memory 268, field programmable gate array (‘FPGA’), complex programmable logic device (‘CPLD’), application-specific integrated circuit (‘ASIC’), a hard-wired network of asynchronous or synchronous logic, and otherwise.

The processor is coupled through a memory bus 257 to computer memory 268, which in this example is used to store measurements 215 of the drilled holes 280 as well as design 216 measurements for comparison with the actual measurements. The processor 156 of FIG. 3 executes the hole analysis module(s) 270 to determine by comparison of design measurements 216 and the measurements 215 of the drilled hole 280 whether the hole as drilled is within a preset design tolerance. Design tolerance can be further modified by the hole analysis module(s) 270 with additional data related to drilled holes 280 that fail over time. Thus the hole analysis module(s) 270 can be configured to reject or modify preset design tolerance as comparisons with the preset tolerance are associated with rapid changes in the configuration in the drilled hole 280.

The hole analysis module(s) 270 can also be programmed to infer from the measurements 215 whether, for example, a crack exists in the drilled hole 280 or whether a burr exists on the top and bottom surfaces of a drilled hole 280. The hole analysis module(s) 270 (e.g., in conjunction with the robot control module 271) can control the optical probe 101 to inspect the top and bottom surfaces of drilled holes 280 for burrs and the inside surface of drilled holes 280 for variations in surface finish that may indicate a crack. The hole analysis module(s) 270 in such embodiments is programmed to determine according to image processing algorithms the location of the light source 382 and optical probe 101 in the image of the received reflection of projected rings 138, and the light source 382 and optical probe 101 are configured for an expected surface finish for the material that is being inspected. If there is a significant deviation in surface finish indicating a crack or if there are burrs, at least one received reflection of a projected ring 138 of light will not appear as a radially symmetric ring in the image generated by the optical sensor 212, rather the image will have significant local variations in its appearance. That these variations are greater than a threshold is an indicator of a surface defect such as a burr or crack. Burrs can also be identified from white light images of the entrance and exit of the hole because the edge of the drilled hole 280 will not appear smooth and round. The bottom-facing surface of the drilled hole 280 can be imaged by an optical probe 101 configuration whereby a telecentric or low field of view lens images reflections off a cone mirror. In such embodiments, the imaging light 323 is configured so that reflections 336 of projected rings of light first reflect off of the mirror 344 and then back through the lens to the optical sensor 212 rather than first striking the lens itself.

The exemplary probe 101 of FIG. 3 is provided for explanation and not for limitation. The optical probe 101 optionally comprises a telecentric or low field of view lens, a double cone mirror, and light sources located proximal and distal to the double cone mirror. The lens images the proximal-facing aspect of the double cone mirror. In some cases, the full angle of the side of the cone mirror proximal to the lens is greater than 90 degrees to permit viewing of reflections from the cone mirror that originate at locations that are proximal to the apex of the cone mirror. A proximal white light source may provide illumination for inspecting the bottom-facing surface of the drilled hole. A distal light source directs light to a distal-facing aspect of the double cone mirror that reflects the light laterally. An additional distal light source may provide white light for inspecting the top-facing surface of the drilled hole.

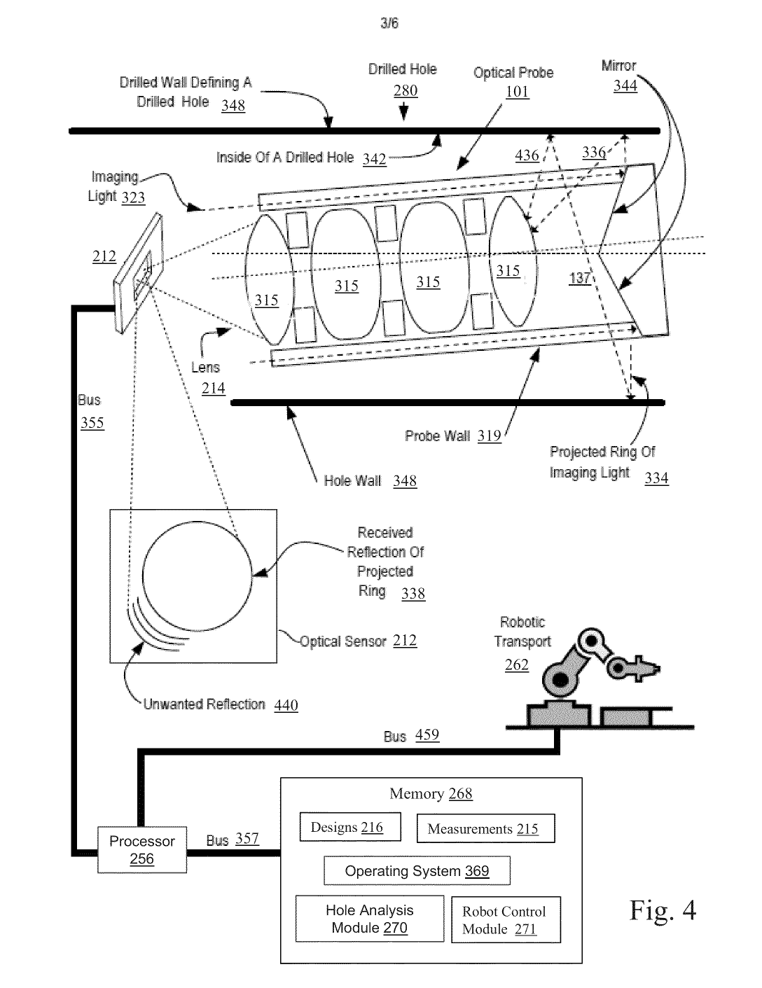

To provide further explanation of orientation or calibration of an optical probe 101 within a drilled hole 280, FIG. 4 depicts further exemplary apparatus for optical measurement of drilled holes that includes an optical probe 101 whose center axis 488 is tilted with respect to the center axis 490 of the drilled hole 280 in which the optical probe 101 is moving. The robotic transport 262 in this example is adapted to receive from the processor 256 (e.g., executing a robot control module 217) through extension bus 459 instructions to align the optical probe 101 with the center axis 488 of the optical probe parallel to the center axis 490 of the drilled hole 280 for minimal unwanted reflection 440.

The unwanted reflections 440 result from the tilt of the probe with respect to the drilled hole 280, allowing at least some of the reflected light 437 to reflect through the optical probe 101 and effect a second reflection 446 off the opposite wall of the hole before arriving at the lens 214, thereby making the appearance of a first reflection that is actually a second reflection, in effect, producing noise that indicates a wrong placement of the optical probe 101 in the space of the drilled hole 280. The hole analysis module(s) 270 may detect the tilt by noting in its scan of optical data signals from the optical sensor 212 that, in addition to the received reflection of a project ring 338, the optical sensor 212 also bears illuminated pixels outside the ring, that is, illuminated pixels representing one or more unwanted reflections 440, e.g., unwanted reflection caused by the tilt of the optical probe's center axis 490 with respect to the center axis 488 of the drilled hole 280. The hole analysis module(s) 270 may alert the robot control module 271 of the unwanted reflections 140 and the robot control module 271 may then instruct the robotic transport 262 to tilt the optical probe 101 until the unwanted reflections 140 are minimized, thereby aligning the optical probe 101 within the drilled hole 280. The unwanted reflections 140 may not be completely eliminated, but minimizing them will sufficiently align the optical probe 101 to facilitate good quality measurement of the drilled hole 280.

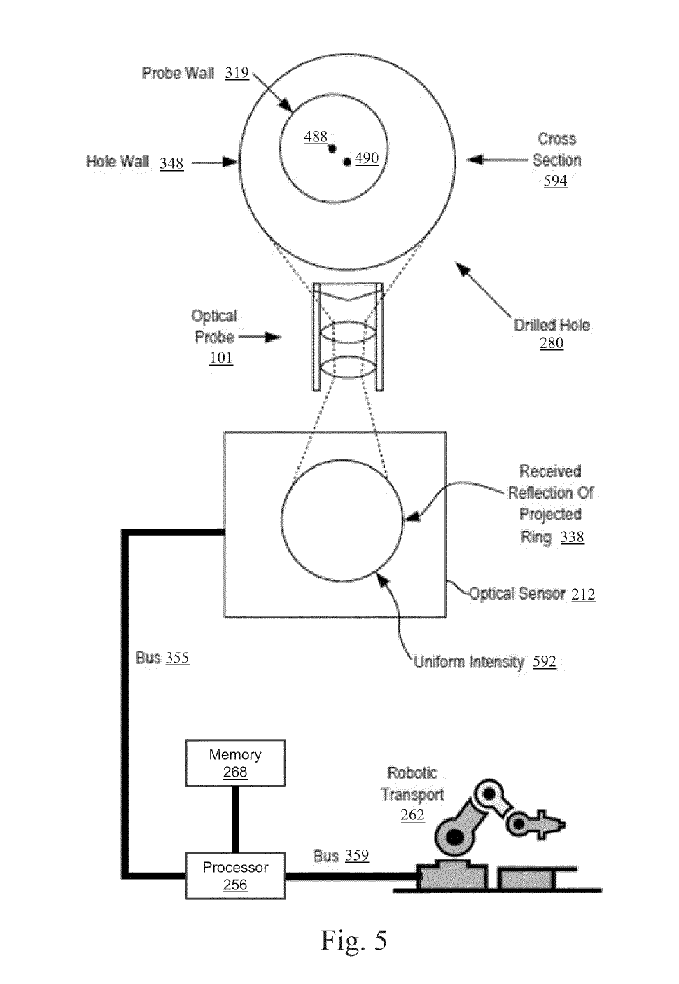

To further explain orientation or calibration of an optical probe within a drilled hole, FIG. 5 depicts an exemplary apparatus for optical measurement of drilled holes that includes an optical probe 101 whose center axis 188 is parallel to the center axis 190 of a drilled hole 280 but not located exactly on the center axis 190 of the drilled hole. In fact, there is no requirement for the orientation of a probe to be exactly aligned on a center axis of a drilled hole in order to measure the hole. On the other hand, it is desirable for pixels that illuminate on a sensor 112 a received reflection of a projected ring 138 to be substantially uniform in intensity to support ease of image processing by a processor 156.

In the example of FIG. 5, therefore, the robotic transport 262 is adapted to position the optical probe 101 for uniform intensity 592 of the received reflections of projected rings 338 received by the optical sensor 212. That is, the robotic transport 262 in this example is adapted to receive from the processor 156 (e.g., executing the robot control module 271) through extension bus 359 instructions to position the optical probe 101 so that received reflections of projected rings 338 illuminate pixels of the sensor 212 with uniform intensity 592. Of course “uniform intensity” is an engineering term that does not require exact uniformity. In this sense, “uniform” can be taken to mean, for example, matching a statistical mean within some predetermined variance, such as, for example, one standard deviation. Such a procedure, positioning, which is to say moving, the optical probe 101 to achieve such uniformity of illumination may well move the optical probe 101 toward the center of the drilled hole 280, but there is still a requirement of exact center alignment, and, in fact, in practice, such an exact center alignment would rarely be achieved and would be so time consuming and costly to achieve as to be of little commercial value. What is typically desired is to avoid positioning the optical probe 101 so close to a hole wall 348 as to illuminate extremely bright pixels on one side of the ring image (i.e., the received reflection of the projected ring 338) and extremely dim pixels on the other side, thereby rendering the hole analysis module's 270 job more difficult.

The hole analysis module 270 in this example therefore averages the intensity values as read from illuminated pixels in the received reflection of a project ring 338 of imaging light 323, calculates an average intensity value, and instructs the robotic transport 262 to position and reposition the optical probe 101 until all the pixels in the received reflection of the projected ring 338 have values within some predetermined variance from the average. The resulting positioning of the optical probe 101 typically will not be exactly on the center axis 488 of the drilled hole 280, but that is typically of little or no concern.

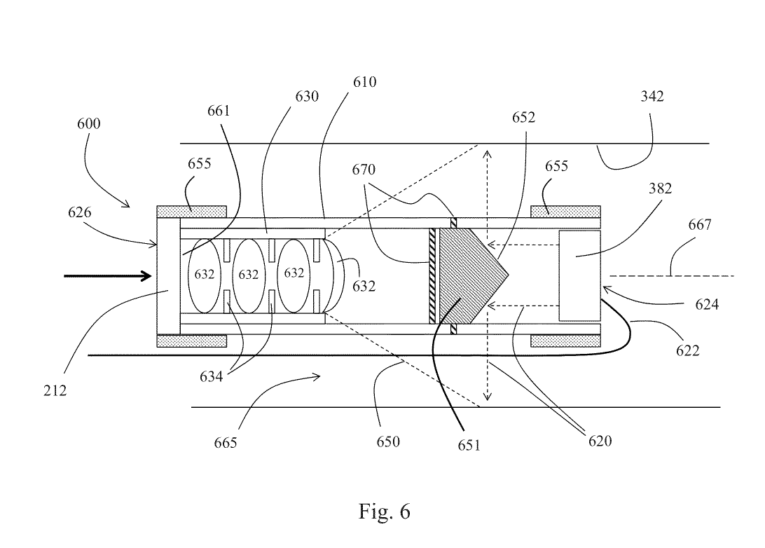

The optical probe 101 described above is but one example of a suitable optical probe for performing the methods described herein. Other optical probe embodiments are described. FIG. 6, for example, provides an illustration of an optical probe 600 that includes an illumination source 382 that is on the opposite side of the probe as the optical sensor 212. Locating the illumination source 382 away from the optical sensor 212, so that the illumination path 620 and optical section signal path 650 are separated from one another, may reduce the risk of interference between the optical section signal path 650 and the illumination path 620. The illumination path 620 in this configuration is defined in part by an optical element 651 having, for example, a conical surface 652. Similarly, the optical section signal path 650 is defined in part by a lens assembly 630 or other suitable optical element(s).

The illumination source 382 may be at least one laser, light emitting diode or other light source as described above. The illumination source 382 in FIG. 6 comprises a laser. The illumination source 382 may be powered by way of a power cord 622.

As shown in FIG. 6, some of the illumination projected onto the inside surface 342 of the drilled hole 280 is reflected towards the optical sensor 212. This reflected illumination (described above as a received reflection of projected a ring 338 of light) represents an optical section signal because it is indicative of a two-dimensional cross-sectional shape of the drilled hole 280 transverse to the probe body 610 and the probe body 610 is smaller in cross-section than that of the drilled hole 280. Optionally, the optical sensor 212 is a detector, a camera, or a sensor based on charge-coupled device (“CCD”), complementary metal oxide semiconductor sensor (“CMOS”) or charge injection device (‘CID’) technology.

It will be appreciated that certain elements, such as the illumination source 382 or optical sensor 212, may not necessarily comprise part of the optical probe 600. Accordingly, the illumination source 382 may be external to the optical probe 600; the optical sensor 212 may be external to the optical probe 600, or both may be external to the optical probe 600.

One or more heat sinks 655 may optionally be coupled to the probe body 610 or illumination source 382. The heat sink 655 slows down heating of the optical probe 600 by transferring heat generated by the optical illumination source 382 away from the optical illumination source 382 and other components of the optical probe 600. The heat sink 655 may be a metal ring or other material that will conduct heat away from the optical illumination source 382.

The optical element 651 optionally includes a conical surface 652 to direct illumination from the illumination source 382 along the illumination path 620. In this illustration, the optical element 651 comprises a single conical mirror. When the optical probe 600 is moved distally (or proximally) into a drilled hole 280 along a probe axis 667 and the optical probe 600 is in operation, the illumination source 382 directs illumination along the illumination path 620 substantially parallel to the probe axis 667 and to the conical surface 652, where the illumination is directed radially outwardly from the probe body 610 so as to illuminate the inside surface 342 of the drilled hole 280.

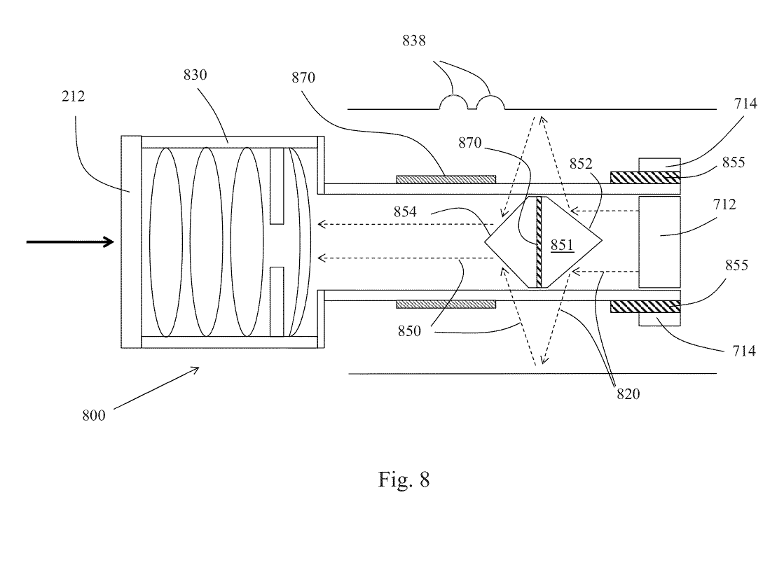

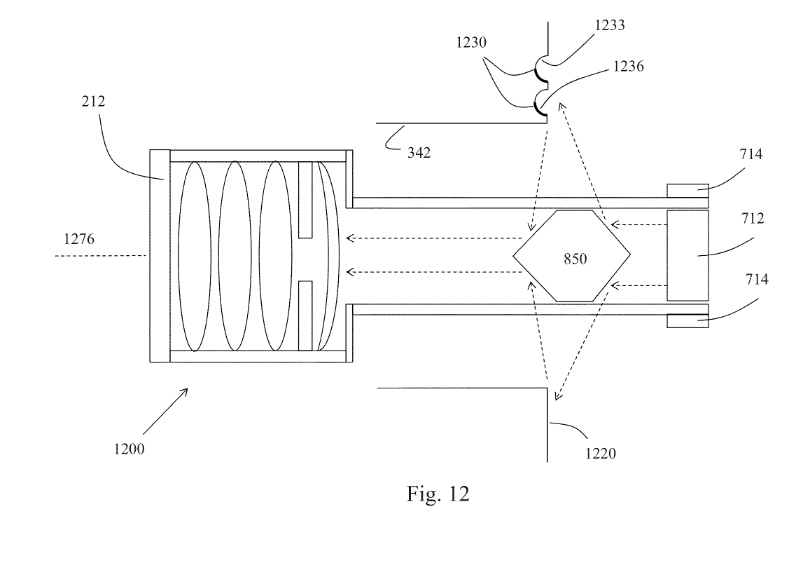

The emitted illumination reflects from the inside surface 6342 of the drilled hole 280 to forms the optical section signal, which follows the optical section signal path 650, through the lens assembly 630, and onto a sensor surface 661 of the optical sensor 212. The lens assembly 630 includes a plurality of lenses 632 separated by a plurality of spacers 634. In addition to the components illustrated in the figures and described herein, various other numbers and configurations of lenses and spacers can be used. Furthermore, the light pattern of the illumination that is emitted from the optical probe body 610 in the embodiment of FIG. 6 may be planar, while in other embodiments the light pattern of the emitted illumination may be conical in shape (see., e.g., FIGS. 8 and 12).

As shown in FIG. 6, the illumination source 382 is located at a distal end 624 of the optical probe 600 while the optical sensor 212 is located on the proximal end 626 of the optical probe 600. As explained above, this configuration provides a benefit of locating the illumination source 382 away from the optical sensor 212, thus reducing the risk of interference to the optical section signal. The power cord 622 for the optical illumination source 382 may run alongside the probe body 610 back toward the proximal end 626 of the optical probe 600 as shown in FIG. 6. The optical section signal may be broken, and not continuous, at the point where the optical section signal is blocked by the power cord 622. While this small break in the optical section signal may be acceptable in most applications, if it is desired to acquire a continuous optical section signal at that location of the drilled hole 280, the optical probe 600 could be removed from the drilled hole 280, rotated slightly relative to the drilled hole 280, and then re-inserted into the drilled hole 280 such that the portion of the optical section signal that was previously blocked, or masked, by the power cord 622 would no longer be masked, allowing for imaging of a complete optical section signal at that location of the drilled hole 280.

The exemplary embodiment illustrated in FIG. 6 includes a plurality of mask elements 670 which mitigate optical “noise” such as undesired reflections of light which could interfere with the optical section signal and prevent it from being clearly transmitted to the optical sensor 212. As illustrated in FIG. 6, the mask elements 670 may be located between the optical element 651 and the lens assembly 630 and/or around the circumference of the probe body 610 (not shown). The mask elements 670 may be formed of an opaque material such as polymeric, metallic, or like materials. The mask element 670 may alternatively or additionally be in the form of a coating (e.g., opaque or anti-reflective material coating) on the probe body 610 or may be provided by taping an opaque material onto the probe body 610. Masking can also be accomplished by the processor 256, e.g., executing a hole analysis module 270 or other program module configured to mitigate noise or other undesirable signals from certain regions of the optical probe 600.

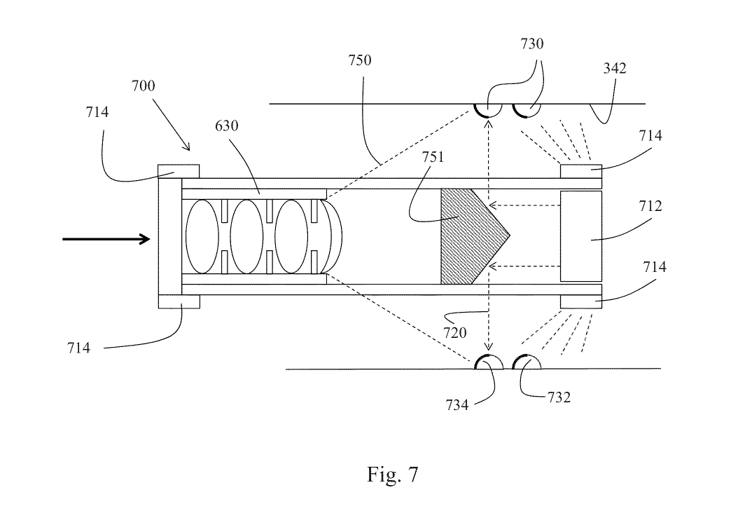

A plurality of illumination sources 382 may be provided on or for the optical probe 600. As a result, additional light, or light from different angles, reaches the inside surface 342 of the drilled hole 280 so as to better allow for determination of certain attributes of the drilled hole 280, such as the presence and dimensions of a burr in the drilled hole 280. FIG. 7 illustrates such an embodiment. As illustrated in the figure, the optical probe 700 includes a laser 712 and a plurality of LEDs 714 as illumination sources 382. The light from the LEDs 714 may be at least partially collimated so as to transmit a semi-collimated light signal towards the inside surface 342 of the drilled hole 280. The LED light can help illuminate burrs 730 and other surface defects within or outside of the drilled hole 280. LED light may, for example, cause a burr to be brighter on the side of the burr 732 that is directly facing the light from the LEDs 714, while the side of the burr 734 facing away from that light will be darker. The difference in the optical section signal acquired in these two regions (732, 734) allows for identification of a burr 730 in the drilled hole 280 by the hole analysis module 270.

FIG. 8 illustrates an exemplary embodiment of an optical probe 800 which includes a double cone mirror 851 that defines, in part, both the illumination path 820 and the optical section signal path 850. The double cone mirror 851 has a first conical surface 852 that in part defines the illumination path 820 and a second conical surface 854 offset from the first conical surface 852, which in part defines the optical section signal path 850. As shown, the first conical surface 852 reflects illumination from the illumination source (e.g., laser, 712) and the second conical surface 854 reflects the optical section signal along the optical section signal path 850 through the lens assembly 830 and onto the optical sensor 212.

As shown in FIG. 8, optical element 851 may be physically divided by a masking element 870 that minimizes noise and other undesirable signals by masking out the optical probe 800 in the center. A further masking element 870 is also shown coupled to the outside surface of the probe body to further minimize interference of the optical section signal. The double cone mirror 851 may alternatively comprise two separate single conical mirrors that are masked there between.

Also shown in FIG. 8 are a series of pits 838. The pits 838 are exemplary of the numerous attributes of the drilled hole 280 that the various embodiments of the optical probe described herein can identify. Other attributes are described above.

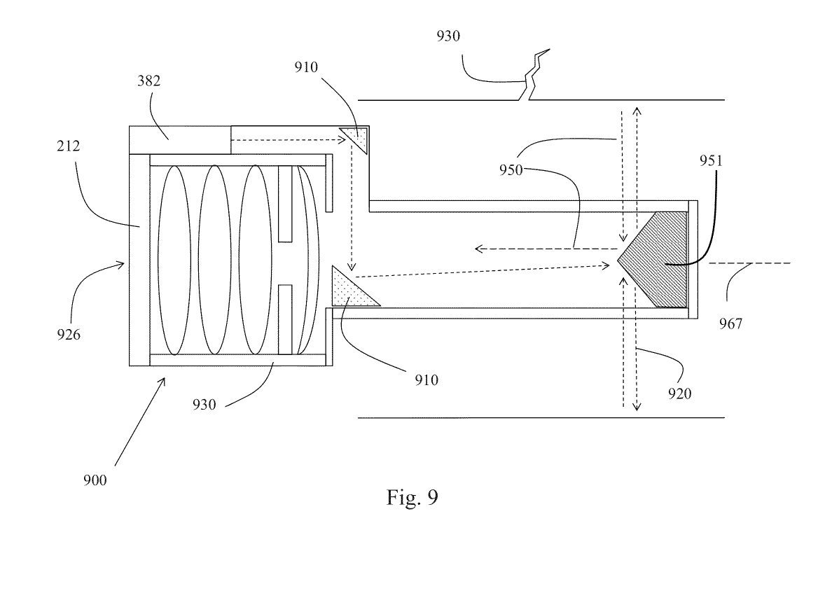

As shown in FIGS. 9-11, an illumination source 382 may be located on the proximal end of the optical probe so that the power cord 622 for the illumination source 382 can also be located at the proximal end of the optical probe to minimize interference with the optical section signal.

As depicted in FIG. 9, the illumination source 382 may be located on the proximal end 926 of the optical probe 900, along with the lens assembly 930 and optical sensor 212. The optical illumination source 382 is shown oriented parallel to the probe axis 967, and mirrors 910 direct light from the illumination source 382 to an optical element 951. The optical element 951 in this example comprises a single conical mirror that defines in-part both the illumination path 920 of illumination extending radially outward from the optical probe and the optical section signal path of illumination reflecting back through the lens assembly 930 and onto the optical sensor 212.

Although FIG. 9 illustrates the use of two mirrors 910 to reflect illumination to the optical element 951, it will be appreciated that any number and/or arrangement of mirrors or prisms may be utilized. Additionally, the mirrors 910 may be floating and/or affixed to a lens of the lens assembly 930. Still further, cube style beam splitters may be employed. Such elements change the illumination path 920 accordingly.

FIG. 9 also illustrates an illumination path 920 that reaches the inside surface 342 of the drilled hole 280, which comprises a crack 930, which as discussed above is among the numerous attributes of the drilled hole 280 that the various embodiments of the optical probe described herein can identify.

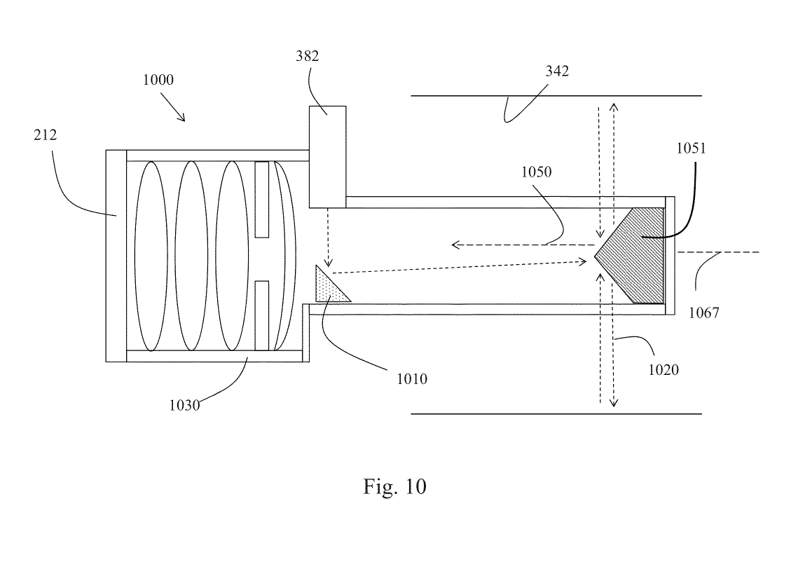

FIG. 10 illustrates an exemplary optical probe 1000 including an illumination source 382 located perpendicular to the probe axis 1067. The illumination source 382 is configured to direct illumination substantially perpendicular to the probe axis 1067 towards a mirror 1010 or prism or other reflecting or refracting device (or a plurality of mirrors, prisms or other optical components in other embodiments) that directs the illumination to the optical element 1051. Illumination reflects from the optical element 1051 along the illumination path 1020 and then reflects back from the inside surface 342 of the drilled hole along the optical section signal path 1050 and through the lens assembly 1030 to the optical sensor 212.

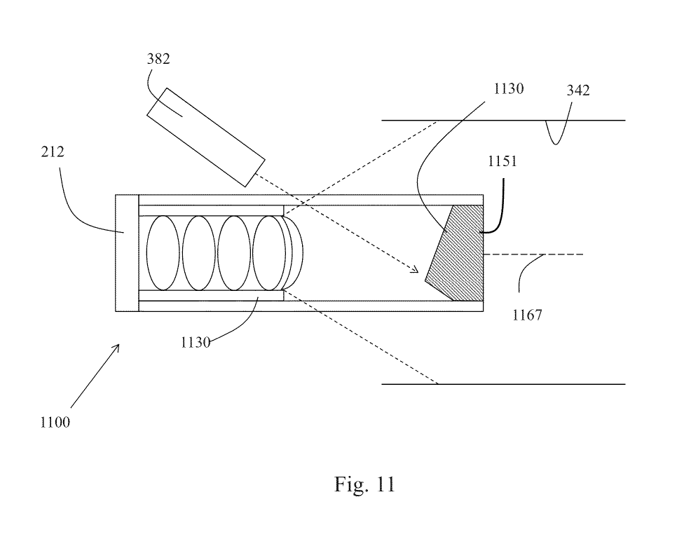

FIG. 11 illustrates an exemplary optical probe 1000 including an optical illumination source 382 that is offset from the probe axis 1167 so as to direct illumination substantially at an angle to the probe axis 1167 and towards the optical element 1151. As shown in FIG. 11, the optical element 1151 may have a conical surface 1130 that is offset from the probe axis 1167. The shape and/or angle of the conical surface 1130 can be adapted to allow it to receive illumination at an angle to the probe axis 1167 and direct it along a desired illumination path 1120. In this example, illumination reflecting from the inside surface 342 of the drilled hole 280 may pass through the lens assembly 1130 and to the optical sensor 212 without hitting the optical element 1151.

As explained above, the optical probe described herein can be used to identify attributes of a structure surface proximate a drilled hole. FIG. 12 provides a purely exemplary illustration of this capability. As the exemplary optical probe 1200 is moved along axis 1267 into and out of the drilled hole 280, the optical sensor 212 can receive optical section signals of the exterior surface 1220 proximate the drilled hole 280, which could allow the hole analysis module 270 to identify attributes of the exterior surface 1220. For example, the hole analysis module 270 could identify pits 1230 on the exterior surface 1220 by identifying differences in optical section signals resulting from a brighter side 1233 and/or darker side 1236 of the pits 1230. Attributes of the exterior surface 1220 could be identified at the distal end of the drilled hole 280 as the optical probe 1200 is moved proximally, or they could be identified on the proximal end of the drilled hole 280 as the optical probe 1200 is being initially moved distally into the drilled hole.

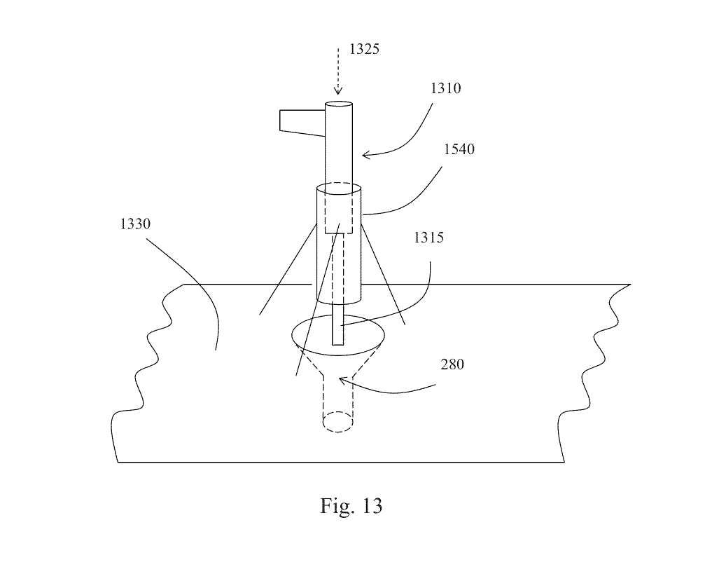

An optical probe such as those described above may be incorporated into a robotic system as described herein or into a hand-held system. FIG. 13 illustrates an exemplary hand-held optical probe 1310. The hand-held optical probe 1310 has a distal end 1315 that may be manually inserted along axis 1325 into a drilled hole 280 in a structure 1330 such as an airplane wing. In the illustrated example, the drilled hole 280 is a countersunk hole.

The hand-held optical probe 1310 is inserted into the drilled hole 280 along an axis 1325 that is parallel to the axis of the drilled hole 280. While a robotic system may be able to readily achieve the proper alignment of the optical probe 1310, an operator manually using the hand-held optical probe 1310 to achieve the desired probe alignment would have more difficulty. Thus, the hand-held optical probe 1310 in combination with a mounting system can be affixed to the drilled structure 1330 to ensure proper alignment between the optical probe 1310 and a center axis 1325 of the drilled hole 280. Such a mounting system can include the tripod system 1340 such as that shown in FIG. 13, or it could be a clamp, adaptor plate, suction cup, guide or other structure coupled to the hand-held optical probe 1310 to establish alignment between the optical probe 1530 and the drilled hole 280. The hand-held optical probe 1310 shown in FIG. 13 may incorporate features of the exemplary optical probes described above.

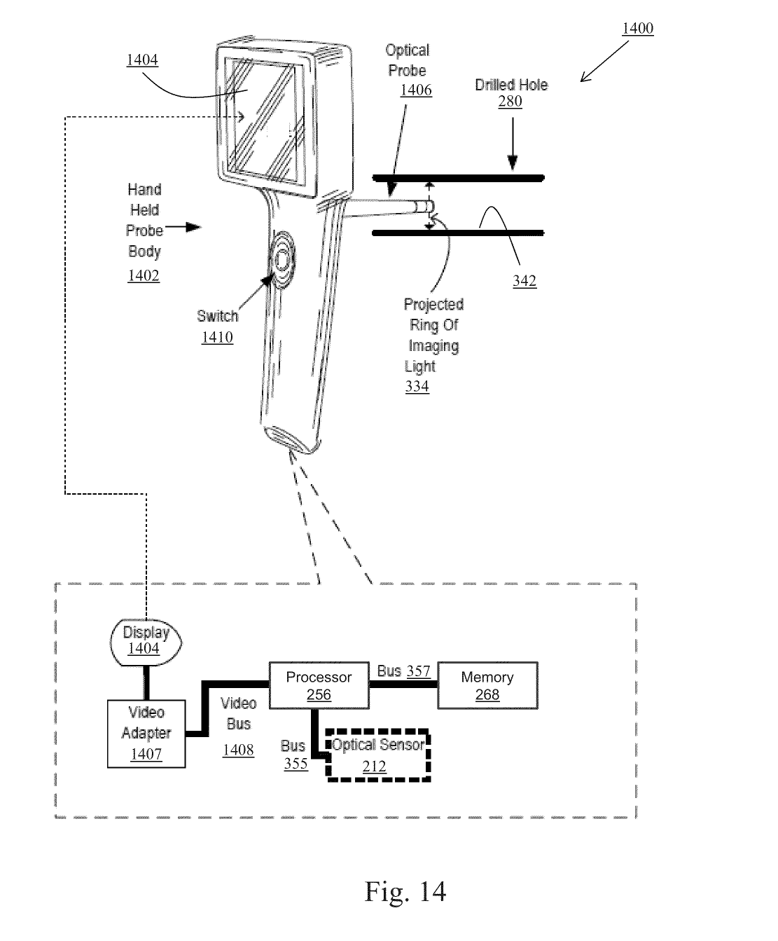

An example of a hand-held probe apparatus 1400 is shown, purely by way of illustration, in FIG. 14. The hand-held probe apparatus 1400 in the example of FIG. 14 includes an optical probe 1406. In this example, the optical probe 1406 is mounted upon a hand held probe body 1402, and the probe body 1402 also has mounted upon it a graphic display 1404. An optical sensor 212 is positioned in the probe body 1402 with respect to the optical probe 1406 so as to sense reflected light, and the optical sensor 212. As described, output from the optical sensor 212 may be processed by a hole analysis module 270, which in this example may be executed by a processor 256 included within the probe body 1402. In other embodiments the hole analysis module 270 may be executed by a computing device with which the hand-held probe apparatus 1400 is in communication. The processor 256 is operably coupled to the display 1404, such as by way of a video bus 1408 and video adapter 1407, so as to display images of received reflections of rings 338 of light from the inside of a drilled hole 280. The hand-held probe apparatus 1400 also includes a light source, which not shown in FIG. 14 but may be similar to those depicted and described above, that projects, as the optical probe 1406 is moved, one or more rings of light 334 on the inside surface 342 of the drilled hole 280 and a processor 256 executes a hole analysis module 270 that determines from the received reflections measurements of the drilled hole 280.

By use of the display 1404, an operator moves the probe 1406 inside a drilled hole 280 by hand, tilts the probe to minimize unwanted reflections, positions the probe for uniformity of pixel intensity, and, when the probe is aligned as desired, presses a switch 1410 to instruct the hole analysis module 270 to capture the image presently illuminated on the sensor 212 and measure the drilled hole 280. In the apparatus 1400 of FIG. 14, the hole analysis module 270 determines whether the hole 280 as drilled is within a design tolerance as described above by comparison of design dimensions 316 and the measurements 314 of the drilled hole 280. With the apparatus 1400 of FIG. 14 the hole analysis module 270 may also be programmed to infer from the measurements 314 whether a crack, or other attribute, is present in the wall of the drilled hole 280.

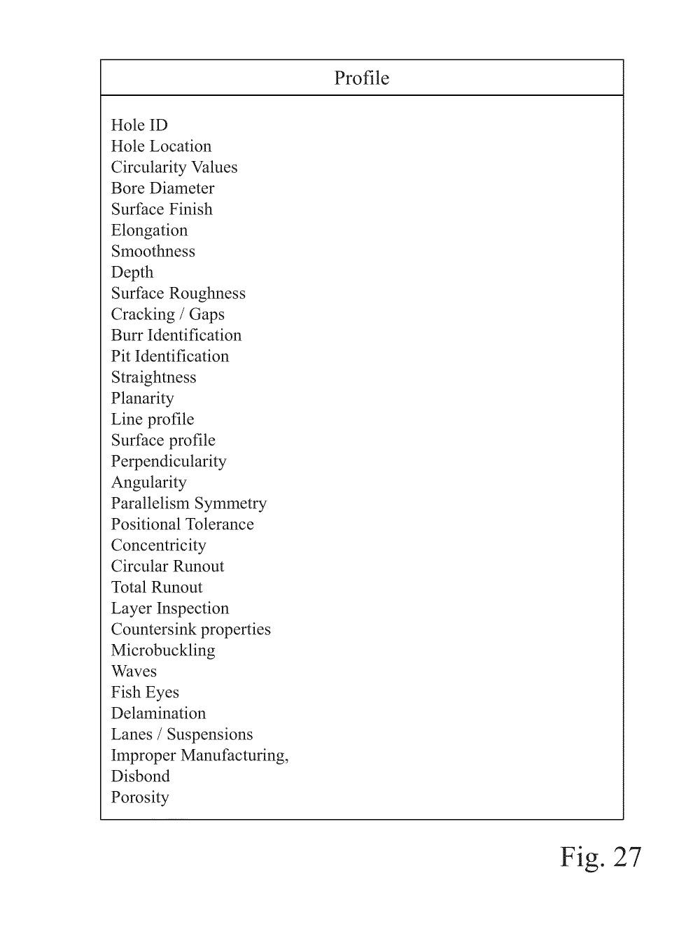

The apparatus 1400 of FIG. 14 can be used to produce a profile (including, for example, a 3D reconstruction) of a drilled hole 280 as described above. The profile can be rendered on the display 1404. An exemplary profile data structure is shown in FIG. 27 and can include some or all (or other) of the listed attributes of a drilled hole 280.

Alternatively, or additionally, the profile or data for various attributes for the drilled hole 280 may be stored in a local memory 268 or the memory of a remote computing device or memory storage device for further use, optionally with data from other holes, in various methods such as those described herein. Such methods include, but are not limited to, tracking changes to the drilled hole 280 over time, determining whether the drilled hole 280 or other holes is/are or may go out of tolerance in the future, and determining whether the drill used to drill the hole 280 is damaged.

Additional optical systems are described in the following patent applications, also assigned to the assignee of the present invention, which are incorporated herein by reference in their entirety for all purposes: U.S. patent application Ser. No. 13/417,767 filed Mar. 12, 2012 and published as US 2012/0281071 on Nov. 8, 2012; U.S. Provisional Patent Application No. 41/466,863 filed Mar. 23, 2011; U.S. patent application Ser. No. 13/417,649 filed Mar. 12, 2012; U.S. patent application Ser. No. 13/767,017, filed Feb. 14, 2013.

Robotics and Optical Probe Deployment Systems

The present invention additionally provides for robotics, such as optical probe deployment systems, to move the optical probe body continuously between first and second locations along a probe path extending into a drilled hole while the optical probe provides continuous, real-time scanning of the drilled hole. The robot additionally provides signals indicative of the location and/or orientation of the probe along the probe path associated with the optical signals transmitted from the optical probe. Advantageously, the present system is able to provide a complete image of the inside of the drilled hole for improved accuracy and verification of hole integrity and configuration (including for example, diameter and circularity), identification of out-of-tolerance holes, and inspection speed, as well as more accurate drill life estimates.

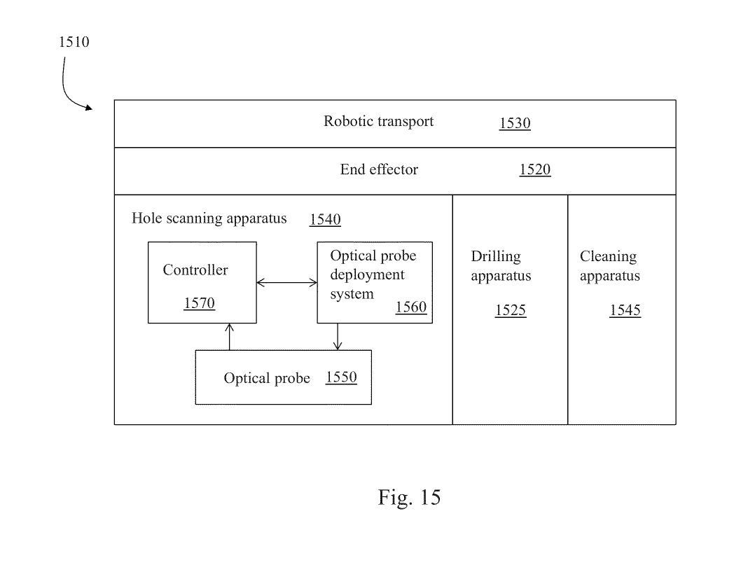

FIG. 15 shows components of a system 1510 including an all in one end effector 1520 that houses all necessary tools on board and a robot transport, gantry or other machine system 1530 for moving the end effector 1520. The end effector 1520 includes a drilling apparatus 1525 for making precise holes in a work piece, hole scanning apparatus 1540, cleaning apparatus 1545, and other tools as desired so as to advantageously provide a single solution end effector.

The hole scanning apparatus 1540 includes an optical probe 1550, optical probe deployment system 1560 and processor 1570. Under control of the processor 1570 (e.g., executing a robot control module 271), the optical probe deployment system 1560 moves the optical probe 1550 over a drilled hole 280 and then into the drilled hole 280. Once the optical probe 1550 is inside the drilled hole 280, the deployment system 1560 continuously moves the optical probe 1550 along an inside depth of the drilled hole 280. As the optical probe 1550 is continuously moved, the optical probe 1550 is continuously scanning the inside surface 342 of the drilled hole to provide a complete image of the diameter and circularity the drilled hole 280. It will be appreciated that the optical probe 1550 may comprise any of the embodiments described herein.

In addition to controlling the deployment system 1560, the processor 1570 (e.g., executing a hole analysis module 270) also processes optical probe data from an optical sensor 212 or detector of the optical probe 1550. The processing includes determining whether the drilled hole 280 is within a predetermined tolerance via comparison with design criteria 316. Optionally, the controller 1570 (e.g., executing a hole analysis module 270) may provide data to the robot or gantry 1530 indicating whether the drilled hole 280 is within tolerance or may directly provide the optical probe data to the robot or gantry.

Optionally, the optical probe deployment system 1560 may include a piezoelectric motor (not shown) for continuously moving the optical probe 1550 within the drilled hole 280. The optical probe deployment system 1560 may further include a miniature actuator (e.g., an air cylinder, linear motor, hydraulic cylinder) for moving the optical probe 1550 over a drilled hole 280.

The combination of the optical probe 1550 and the piezoelectric motor results in a hole scanning apparatus 1540 that is very small in size. The small size allows the hole scanning apparatus 1540 to be mounted to the end effector 1520 in a location that allows each hole to be measured immediately after drilling. Inspecting each hole after drilling is highly advantageous. It allows problems such as worn and chipped drill bits to be identified immediately, and prevents subsequent holes from being drilled with such drill bits.

The drilling apparatus 1525, hole scanning apparatus 1540, and cleaning apparatus 1545 may be rotatably mounted on the end effector 1520 or fixed on the end effector 1520. Alternatively, the end effector 1520 may allow for tools to be exchanged on the end effector and still further the hole scanning apparatus 1540 may be the only operable device on the end effector 1520 while drilling apparatus 1525 and cleaning apparatus 1545 may be mounted on entirely separate transports. The cleaning apparatus 1545 may include a compressed air nozzle, an industrial wire or non-wire brush, and/or a vacuum to clean the drilled hole and/or optical probe.

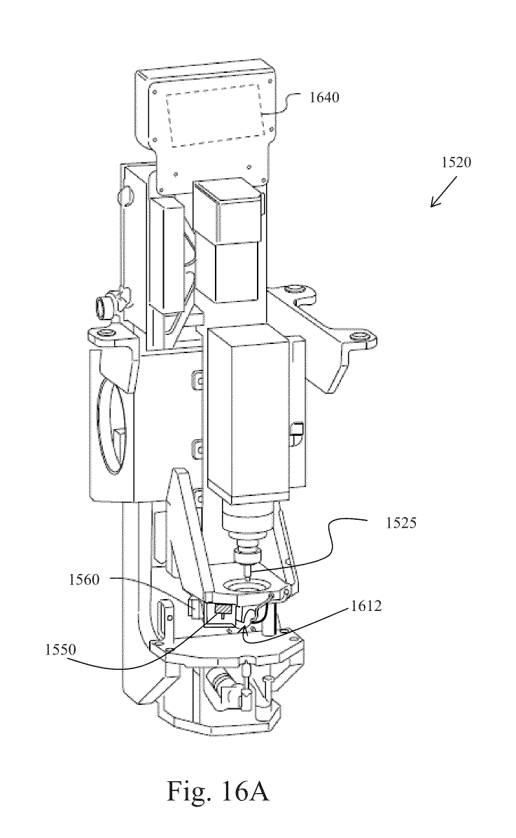

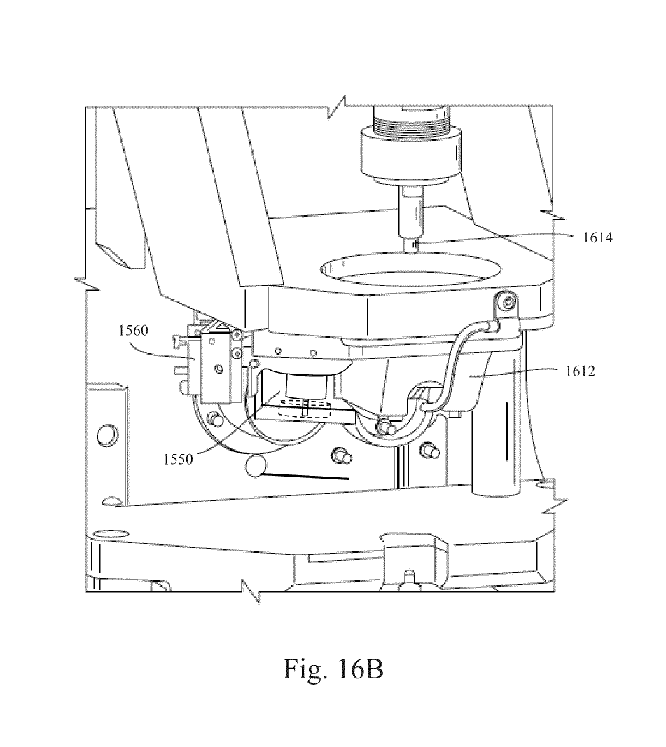

FIGS. 16A and 16B illustrate an exemplary end effector 1620. The end effector 1620 includes a pressure foot 1712 for holding a work piece or clamping together two or more work pieces. The end effector 1620 further includes a drill bit 1714 for drilling a hole in the work pieces(s). During drilling, the drill bit 1714 moves through a passageway in the pressure foot 1712 and bears down on the work piece(s).

FIGS. 16A and 16B also illustrate a hole scanning apparatus including an optical probe 1650 and an optical probe deployment system 1660. In one particular embodiment, the drill bit 1714 is used to drill a hole. The optical probe 1650 has a diameter that is less than the diameter of the drilled hole 280. The optical probe 1650 may be configured to ensure non-contact with the inside of the drilled hole.

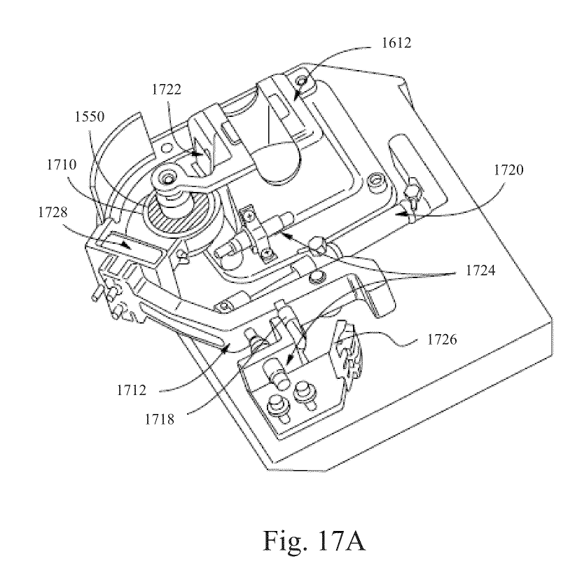

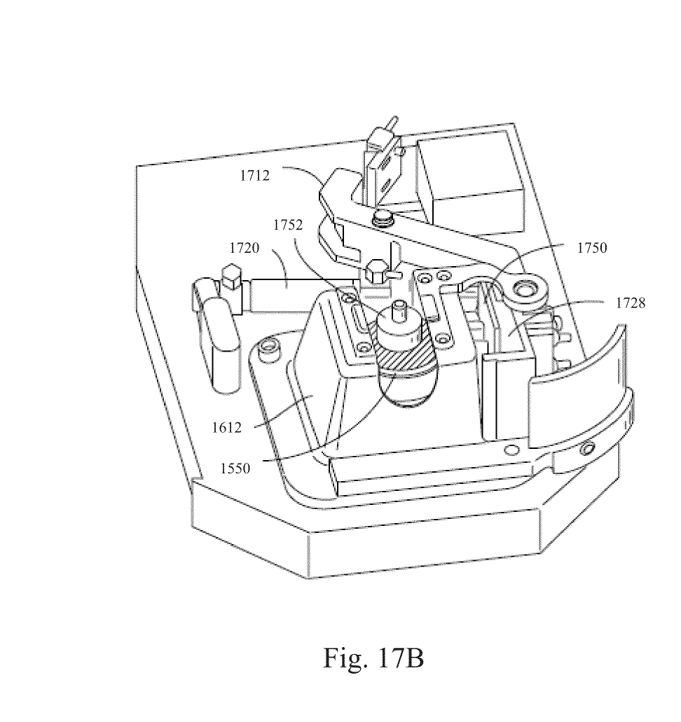

FIGS. 17A and 17B are enlarged isometric views of the optical probe deployment system 1660. In particular, FIGS. 17A and 17B show how the optical probe 1650 is moved from a home position outside of the pressure foot 1712, to a deployed position inside the pressure foot 1712 and over a drilled hole.

FIG. 17A shows the optical probe 1650 in the home position. The optical probe 1650 is attached to an optical probe arm 1812 by a flexible mount 1810. A first limit switch 1818 indicates when the arm 1812 is positioned such that the optical probe 1650 is completely out of the pressure foot 1712.

The optical probe 1650 is deployed by turning on a solenoid valve (not shown) to actuate an air cylinder 1820, causing the optical probe arm 1812 to swing and move the optical probe 1650 through an access door 1822 and into the pressure foot 1712. Shock absorbers 1824 reduce the abrupt shock of stopping the optical probe arm 1812 over a short distance. The shock absorbers 1824 also function as stops for accurately positioning the optical probe 1650. A second limit switch 1826 indicates an arm position where the optical probe 1650 is inside the pressure foot 1712.

FIG. 17A also shows a piezoelectric linear motor 1828, which moves the optical probe 1650 continuously through the inside depth of the drilled hole. The piezoelectric linear motor 1828 may be operated using high frequency pulses. These high frequency pulses may be tuned to the piezoelectric crystal frequency, which results in maximum linear displacement. For example, the relative position of the optical section signal may be determined by the speed of the linear motor 1828, as set by the controller 1670, and/or a frame rate of the optical sensor.

FIG. 17B shows the optical probe 1650 in the deployed position. Once in the deployed position, the processor 1670 controls the piezoelectric linear motor 1828 and its platform 1850 to position the optical probe 1650 in the drilled hole. An optical probe stop collar 1852 may be used to adjust the depth that the optical probe 1650 goes into the drilled hole.

Referring again to FIG. 16A, the hole scanning apparatus 1640 further includes a control box 1740. The control box 1740 includes the processor 1670.

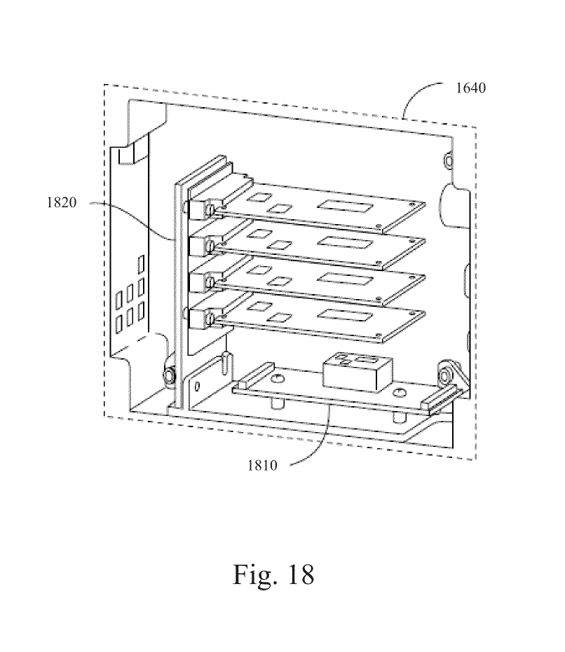

FIG. 18 illustrates an embodiment of the control box 1740. The control box 1740 includes a first circuit board 1910 that can process the optical probe data from an optical sensor or detector of the optical probe 1650. The first circuit board 1910 also computes whether the drilled hole is within tolerance via comparison with design criteria on hole diameter, circularity and other attributes such as those described above.

The first circuit board 1910 also monitors limit switches 1818 and 1826 to assure the optical probe 1650 is in a known position. The first circuit board 1910 also controls the optical probe deployment system 1660 by generating signals that actuate the air cylinder solenoid, and also by supplying signals to a piezoelectric motor driver (not shown), which is on a second circuit board 1920. The piezoelectric motor driver generates the high frequency pulses that drive the piezoelectric linear motor 1828.

The control box 1740 has input and output ports for communicating with the robot or gantry 1630. The control box 1740 may have a data port (e.g., a serial port) for accepting user inputs as well as outputting diagnostics and other information. For instance, the control box 1740 can output hole scanning data for post processing.

The post processing may be used to perform drill life estimates. Typically, drills are automatically replaced according to a fixed schedule (e.g., after drilling a set number of holes). By monitoring the hole diameter and instead replacing drills at the end of their lives (e.g., when wear or damage is apparent), fewer drills are replaced. Consequently, time and money are saved.

As shown in FIG. 16A, the control box 1740 and other hole scanning apparatus are mounted to the end effector 1620. This makes for a standalone unit. All functionality is contained and controlled within the unit. All that is needed is power and a signal to perform a drill hole scanning A robot technician does not have to know how to operate the unit. The unit is little more than a “black box” from the perspective of a robot technician. Moreover, if the unit is moved from one robot to another, all functionality goes with it. Deployment control and optical probe signal processing do not have to be changed each time the unit is moved.

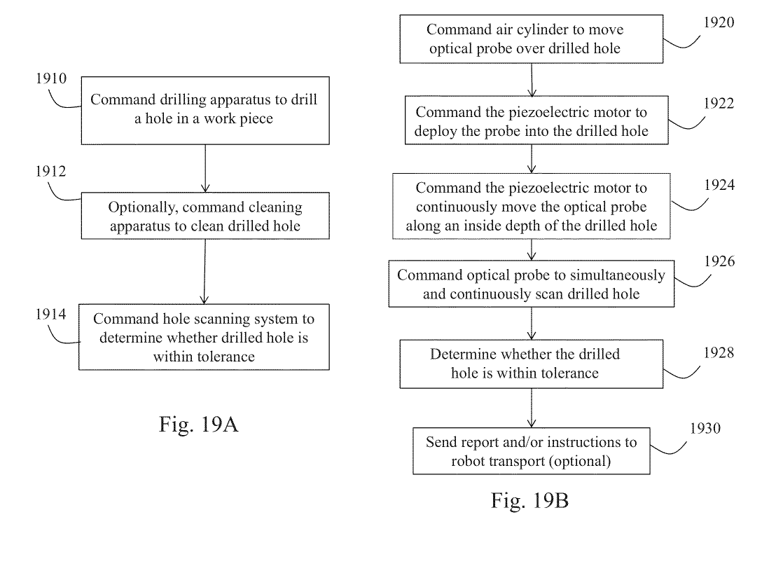

FIGS. 19A and 19B illustrate the operation of the optical scanning system of FIG. 15. Referring first to FIG. 19A, the drilling apparatus 1625 is commanded to drill a hole in a work piece (block 2010). After the hole has been drilled and the drill bit 1714 has been withdrawn from both the hole and the pressure foot 1712, the hole scanning apparatus 1640 is commanded to determine whether the drilled hole is within tolerance (block 2012).

As shown in FIG. 19B, the control box 1740 commands the air cylinder 1820 to move the optical probe 1650 over the drilled hole (block 2020), and it then commands the piezoelectric motor 1828 to deploy the optical probe 1650 into the drilled hole (block 2022). The optical probe 1650 is positioned a distance from the bottom of the hole by pushing the optical probe 1650 until the optical probe stop 1852 contacts the top surface of the work piece. The optical probe 1650 is then continuously moved from the bottom portion of the drilled hole to the top portion of the drilled hole (block 2024). During this continuous movement, the optical probe is continuously scanning the inside of the drilled hole to provide a complete image of the diameter and circularity the drilled hole (block 2026). The hole scanning steps (blocks 2024 and 2026) may optionally be repeated after completion of the continuous scan. It will be appreciated that the optical probe may additionally or alternatively be moved continuously from the top portion of the drilled hole to the bottom portion of the drilled hole so as to continuously scan from the top to the bottom. It will be further appreciated that the optical probe may be moved continuously or uninterrupted along any two locations along the probe path and is not moving indefinitely. The control box 1740 then determines whether the drilled hole is within tolerance (block 2028) based on the optical probe data and the desired tolerance criteria. A report may be sent to the robot (block 2030).

Methods for Measuring a Drilled Hole

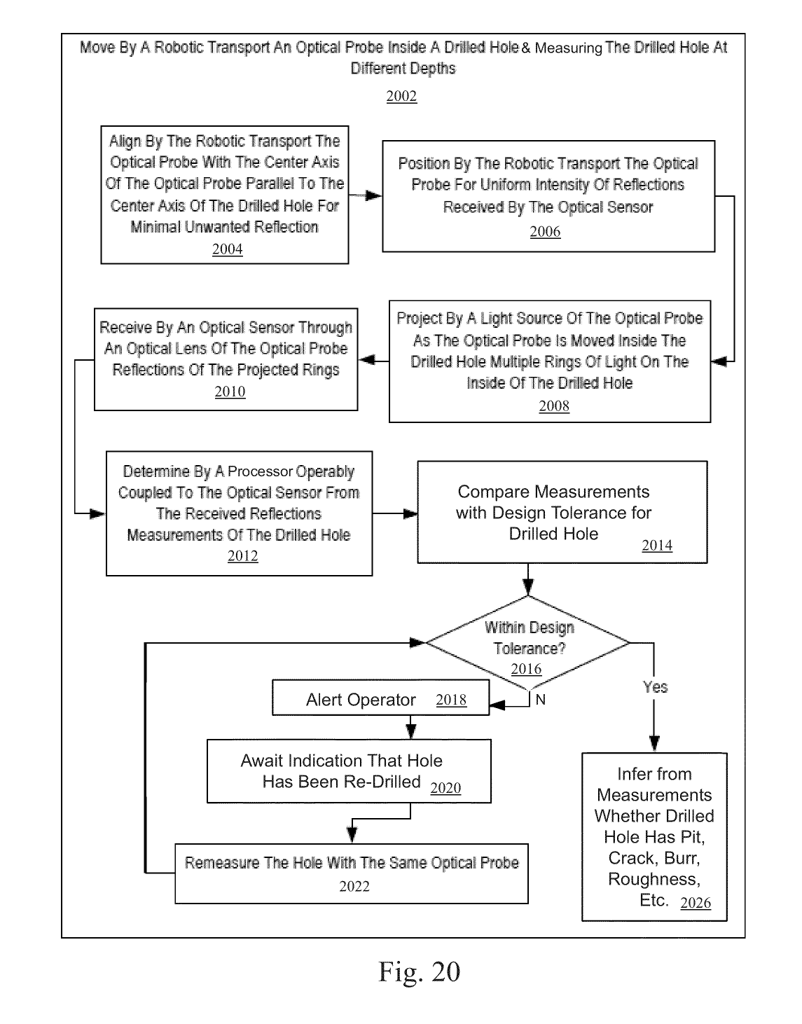

As explained above, optical probes such as those described herein can be used to measure a drilled hole and generate three dimensional images thereof. Measurement includes determining attributes of the drilled hole as described herein. FIG. 20 is a flow chart illustrating an exemplary method of measuring a drilled hole. Although not illustrated in FIG. 20, the method of FIG. 20 is carried out by use of elements of apparatuses discussed above in this specification. For clarity of reference, therefore, those elements are identified in this discussion of FIG. 20 by the reference numerals used to describe them above in the discussion of FIGS. 2-5.

The method of FIG. 20 implements moving 302 by a robotic transport 262 an optical probe 101 inside a drilled hole 280 to measure the drilled hole 280 at one or more depths. The method of FIG. 20 includes aligning 304 by the robotic transport 262 the optical probe 101 with the center axis 188 of the optical probe 101 parallel to the center axis 190 of the drilled hole 280. This alignment is carried out by robotic transport under direction of a processor to achieve minimal unwanted reflection 140 as discussed above with reference to FIG. 4. The method of FIG. 20 also includes positioning 306 the optical probe 101 for uniform intensity of the reflections 138 received by the optical sensor 112, also carried out by the robotic transport 262 under direction of the processor as described above with reference to FIG. 5. As discussed above, in certain embodiments, the moving 302 may be done from a start point to end point continuously and/or without interruption.

The method of FIG. 20 also includes projecting 308 by a light source 182 of the optical probe 101 as the optical probe 101 is moved inside the drilled hole 280 multiple rings 134 of light on the inside 342 of the drilled hole 280; receiving 310 by an optical sensor 112 through an optical lens 114 of the optical probe 101 reflections 136 of the projected rings 134 as discussed above with reference to FIG. 3; and determining 312, by a processor 156 operably coupled to the optical sensor 112 from the received reflections 138, measurements 215 of the drilled hole also discussed above.

The method of FIG. 20 also includes determining 318 by comparison of design measurements 216 and the measurements 215 of the drilled hole whether the hole as drilled is within a design tolerance. After acquiring measurements and images of the hole, the method of FIG. 20 includes comparing the measurements against design tolerance thresholds set by for example an operator or industry standard. An operator may also be alerted if any of the measurements of the hole fall outside the tolerances. For example, an operator may set a diameter error threshold to 1/1000th of an inch (25.4 microns). If the diameter of any of the cross-sections of the drilled hole falls outside of the nominal +/− 1/1000th of an inch, the hole is out of tolerance and a new hole may be redrilled at a larger diameter or an operator may be notified.

The method of FIG. 20 also includes inferring 326 from the measurements 215 a crack in the drilled hole. Inferring 326 from the measurements 215 a crack in the drilled hole may be carried out by inspecting the inside surface of the drilled hole for variations in surface finish that may indicate a crack. Image processing algorithms may be used to determine the location of the light source and probe in the image and the light source and probe are configured for an expected surface finish for the material that is being inspected. If there is a significant deviation in surface finish indicating a crack, the reflected ring of light does not appear as a radially symmetric ring on the sensor, rather it will significant local variations in its appearance. When these variations are greater than a threshold it is a strong indicator of a surface defect such as a crack.

The method of FIG. 20 also includes determining 319 that the hole as drilled fails to meet a design tolerance, redrilling 320 the hole at a larger diameter, and remeasuring 322 the hole with the same optical probe. This ability to remeasure without changing probe tips is a benefit of optical measurement of drilled holes as described herein. Prior art capacitive probes could not do this.

Methods for Identifying a Damaged Drill

Optical probes as described above may be used to identify a damaged drill. In aircraft manufacturing and other applications in which hundreds, thousands, or even more holes may be drilled in a single day, it is desirable to identify a damaged drill as soon as possible. Such damage may take the form of a chipped or bent drill bit or a mis-aligned drill (which could cause the drilled hole to not be perpendicular to the drilled surface). A damaged drill, if not quickly identified, could result in thousands of drilled holes being out of tolerance, necessitating re-drilling of the holes, or worse, replacement of the drilled structure.

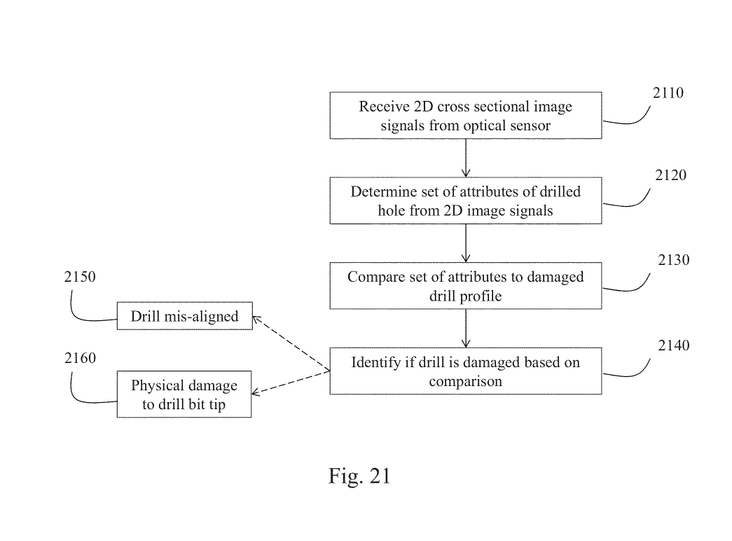

An optical probe as described herein may be utilized in methods and systems for identifying a damaged drill. FIG. 21 illustrates such a method, which includes receiving two-dimensional cross sectional image signals from an optical sensor of an optical probe at associated locations of a probe body of the optical probe along a probe path (block 2110). A set of attributes of the drilled hole is determined from the two-dimensional cross sectional image signals (block 2120). Such attributes may include hole diameter, circularity, elongation, smoothness, roughness, tapering, depth, angularity and/or numerous other attributes such as those described herein.

The set of attributes is compared to a damaged drill profile (block 2130). Based on this comparison of attributes of the drilled hole to the damaged drill profile, a damaged drill can be identified (block 2140). For example, if a chipped bit is known to result in an inside surface of a drilled hole having an exceedingly rough surface, and similar attributes are identified in the drilled hole, then a damaged drill can be identified. Exemplary, but certainly not limiting, types of drill damage include a mis-aligned drill (block 2150) and physical damage to the drill tip (block 2160).

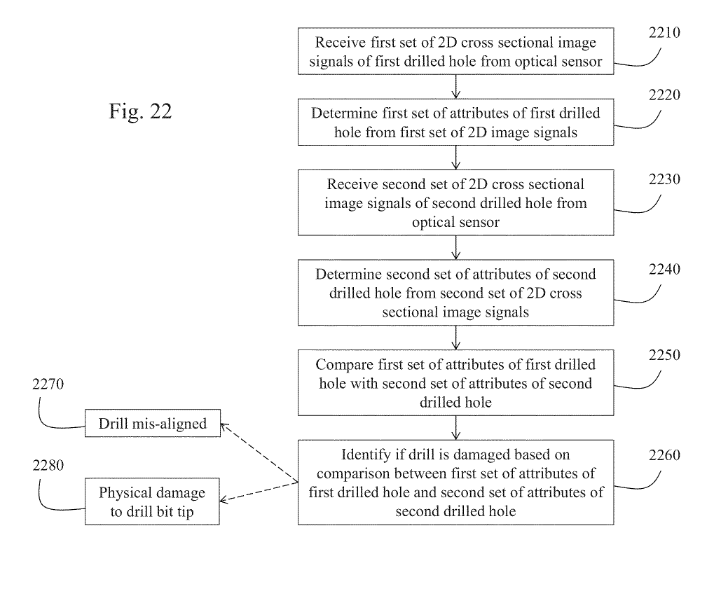

FIG. 22 illustrates a method for identifying damage of a drill by comparing attributes of multiple holes drilled with the same drill bit. A first set of two-dimensional cross sectional image signals of a first drilled hole are received from an optical sensor of an optical probe at associated locations of a probe body of the optical probe along a probe path (block 2210). A first set of attributes of the first drilled hole is determined from the two-dimensional cross sectional image signals (block 2220). Such attributes may include hole diameter, circularity and numerous other attributes such as those described above. A second set of two-dimensional cross sectional image signals of a second drilled hole are received from the optical sensor of the optical probe at associated locations of a probe body of the optical probe along a probe path (block 2230). A second set of attributes of the second drilled hole is determined from the two-dimensional cross sectional image signals (block 2240).

The first set of attributes of the first drilled hole are compared to the second set of attributes of the second drilled hole (block 2250). Damage of a drill (e.g., a mis-aligned drill (block 2270) or damaged drill tip (block 2280)) is identified based on the comparison between the first set of attributes and the second set of attributes (block 2260). The differences between the first set of attributes of the first drilled hole and the second set of attributes of the second drilled hole could also be compared to the damaged drill profile as is described above (block 2140). It will be appreciated that the methods described above and illustrated in FIGS. 21 and 22 may be implemented with an optical probe according to any of the embodiments described herein.

In certain embodiments, multiple sets of attributes of multiple drilled holes can be determined and compared to each other and/or to a damaged drill profile to identify a damaged drill. In this manner, changes in attributes from one drilled hole to another drilled hole (such as consecutive holes that were drilled using the same drill bit) could be used to identify exactly when the drill was damaged. An audio or visual alert could be provided if a damaged drill is identified. Optionally, the drilling operation could automatically be shut down upon detection of a damaged drill.

The identified attributes of the drilled hole can be used to determine whether the drilled hole needs to be re-drilled. Optionally, identification of the damaged drill can be used to determine if the drilled hole should be re-drilled. For example, it may be known from a damaged drill profile that a hole drilled with a drill that was mis-aligned by 3 degrees will necessarily need to be re-drilled.

Optionally, the method includes transmitting the set of attributes of the drilled hole to a storage database. Such attributes may include diameter, circularity, elongation, smoothness, roughness, tapering, depth or angularity. Other attributes of the drilled hole, such as but not limited to those listed above, may also be transmitted to a storage database. The set of attributes of the drilled hole may additionally be associated with hole identification data indicative of a hole location on the structure.

A system for identifying a damaged drill, including a damaged drill tip, may include a computer-readable memory storing a plurality of instructions for controlling a computer system (e.g., processor) to identify a damaged drill tip. The computer system may be configured for use with an optical probe for measuring a drilled hole in a structure, the drilled hole having a drilled hole wall, the optical probe having a probe body movable along a probe path extending into the drilled hole, and the probe body supporting an optical illumination path and an optical signal sensing path.

The plurality of instructions may include instructions that cause the computer system to determine a first set of attributes of a first drilled hole; instructions that cause the computer system to determine a second set of attributes of a second drilled hole; instructions that cause the computer system to compare the first set of attributes of the first drilled hole with the second set of attributes of the second drilled hole to detect one or more differences; instructions that cause the computer system to compare the one or more detected differences to a damaged tip profile; and instructions that cause the computer system to identify if a drill tip is damaged based on the comparison of the one or more detected differences to the damaged tip profile. Additionally or alternatively, the computer-readable memory may further store instructions that cause the computer system to provide an audio or visual alert if the damaged drill tip is identified or other instructions that cause the computer system to carry out any of the steps described above. A first set of multiple two dimensional cross-sectional signals for a hole are stored. Optionally, comparable data for a second set of multiple two dimensional cross-sectional signals for a same hole at a subsequent point in time or a different hole are then compared to the first set of multiple two dimensional cross-sectional signals. Optionally, one or more data points outside a preset tolerance limit for one or more attributes is identified. Such identification can be provided by the processor in the form of a signal to the user.

Methods of Profiling/Inspecting Drilled Holes

Optical probes according to embodiments described above may be used to profile drilled holes and/or inspect drilled holes. The entire “life” of a drilled hole, from its time of initial drilling to retirement of the structure including the drilled hole (e.g., retirement of the aircraft that includes the drilled hole) can be profiled. In addition, the drilled hole profile, or “fingerprint,” can be utilized by various entities for various purposes.

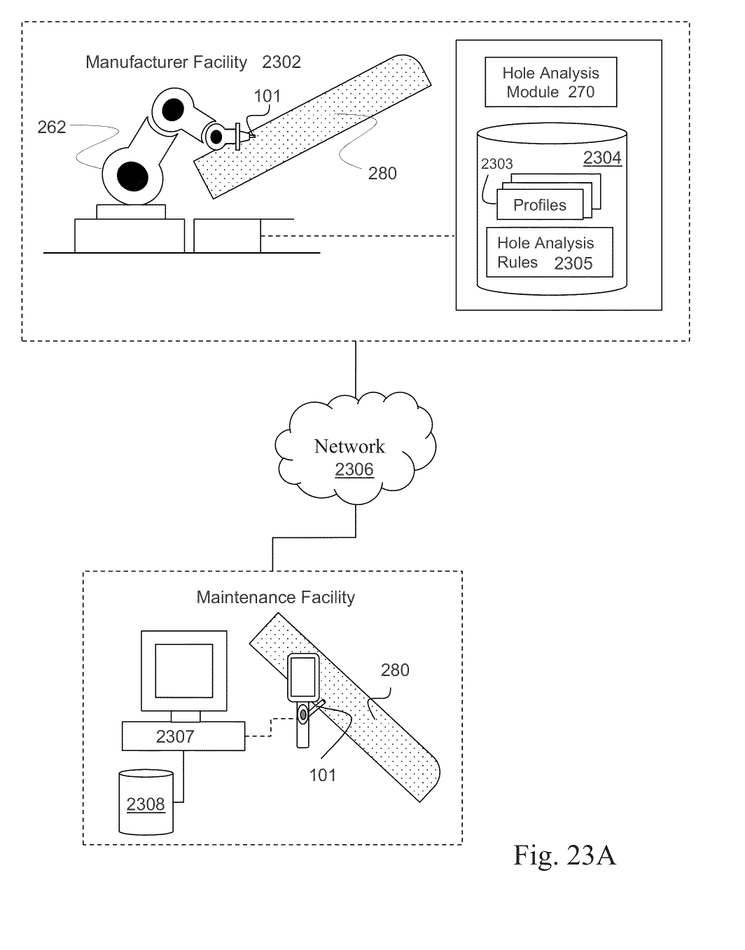

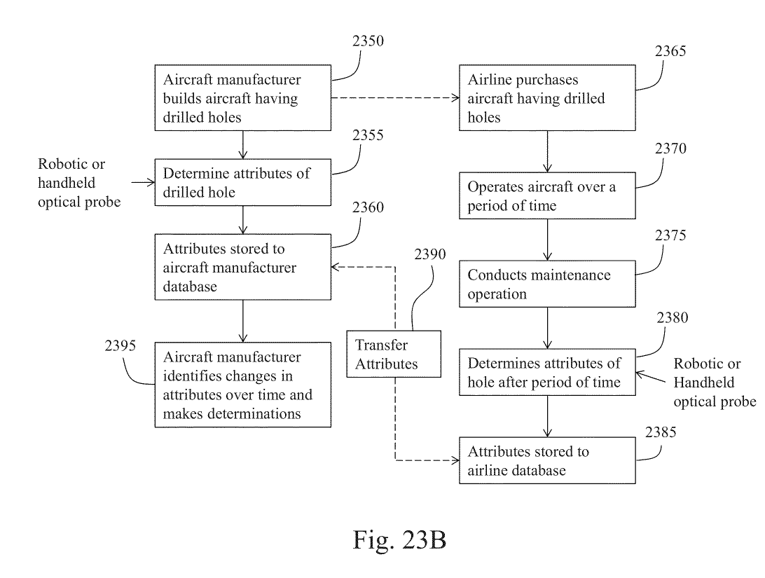

For example, with reference to FIG. 23, an aircraft manufacturer may build an aircraft having drilled holes 2350 and determine attributes of the drilled hole 2355 when the hole is initially drilled and store initial attributes 2360 relating to that drilled hole in a database. The aircraft manufacturer may use a robotic probe or a handheld probe according to embodiments described herein. The aircraft manufacturer may eventually sell the aircraft to an airline carrier 2365, which may operate the aircraft for decades 2370. Over time, the attributes of the drilled hole may change due to stresses on the aircraft and other factors. During periodic airline maintenance operations 2375, and particularly during extensive overhaul operations, is may be necessary for airline maintenance personnel to remove the fastener (e.g., rivet or bolt) retained within the drilled hole and determine attributes of the drilled hole 2380 using a handheld and/or robotic optical probe according to embodiments of the present invention. The airline may store those attributes in a database and send those attributes 2395 to the aircraft manufacturer over the Internet, wide area network (“WAN”) or by other known methods. The attributes of the drilled hole at the later time can be compared to previous attributes corresponding to that drilled hole, including the initial attributes of that drilled hole as stored by the aircraft manufacturer 2395. In this manner, changes in the attributes of that drilled hole over time can be identified and compared to a database of other drilled hole profiles that became out of tolerance over time to determine whether a drilled hole which is currently in tolerance may go out of tolerance in the future. In addition, the attributes of the drilled hole at the later time may be provided to the aircraft manufacturer, to allow the aircraft manufacturer to track or “fingerprint” the drilled hole over time.

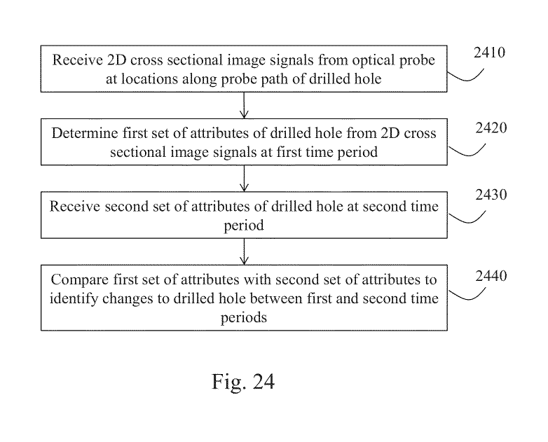

An optical probe according to the present invention may utilized in methods and systems for profiling a drilled hole. FIG. 24 illustrates such a method, which includes receiving two-dimensional cross sectional image signals from an optical sensor of an optical probe at associated locations of a probe body of the optical probe along a probe path, the probe path extending into a drilled hole in a structure (block 2310).

A first set of attributes of the drilled hole is determined from the two-dimensional cross sectional image signals at a first time period (block 2320), and a second set of attributes of the drilled hole at a second time period is received (block 2330). The first set of attributes is compared with the second set of attributes to identify one or more changes that have occurred to the drilled hole between the first and second time periods (block 2340).

Based on the comparison (block 2340) of the same drilled hole over a period of time, it can be determined (or predicted) whether the identified one or more changes result in the drilled hole being out of tolerance or will lead to the drilled hole being out of tolerance in the future. The comparison can include determining one or more changes between the first set of attributes that were in tolerance and the second set of attributes that are not within tolerance.

Optionally, the identified one or more changes is compared to a database of other drilled hole profiles that have become out of tolerance over time. For example, if it is known from a database that a drilled hole having Attribute X at Time Y was found to be out of tolerance when that drilled hole was inspected at Time Z, and a drilled hole is identified as having Attribute X, then it can be determined from the comparison of the drilled hole to the database that the drilled hole may go out of tolerance some time before Time Z. A decision to re-drill the hole prior to Time Z may then be made.

The information acquired by the determinations described above can be used to update threshold values associated with design tolerance criteria for the drilled hole. For example, if it can be determined or predicted that a particular initial attribute of a drilled hole eventually resulted in the drilled hole being out of tolerance (when the second set of attributes was identified), then the threshold value for that attribute could be updated so that when similar attributes in other drilled holes are compared to the updated threshold value, it can be determined that the attribute should be eliminated from the drilled hole (e.g., by re-drilling the hole), thus preventing the drilled hole from going out of tolerance in the future.

Optionally, the first and second set of attributes of the drilled hole may be transmitted to a storage database. The storage database may be maintained by the aircraft manufacturer or the airline carrier or a third party. In one example, the aircraft manufacturer could perform the comparison of stored attributes and notify the aircraft operator that a drilled hole may go out of tolerance in the future.

Sets of attributes for a particular drilled hole may be associated with hole identification data indicative of the location of the hole on the structure (e.g., the aircraft). In this manner, a storage database can be maintained that includes sets of attributes for every hole on an aircraft, and comparisons of changes in attributes for one drilled hole may be compared to changes in attributes of other drilled holes to identify global trends in changes to attributes of drilled holes. In this manner, it may be possible to identify an area of a particular structure having a defect not specifically relating to a single drilled hole by comparing changes in attributes of multiple drilled holes in that area.

The first or second set of attributes may comprise diameter, circularity, elongation, smoothness, roughness, tapering, depth, angularity, or other attributes as described herein. Based on this comparison, hole defects such as burrs, cracks, pits, or other drilled hole defects or unacceptable configurations can be identified.

A system for implementing the method illustrated in FIG. 24 may include a computer-readable memory for storing a plurality of instructions for controlling a computer system to identify a profile for a drilled hole. The computer system may be configured for use with an optical probe for measuring a drilled hole in a structure, the drilled hole having a drilled hole wall, the optical probe having a probe body movable along a probe path extending into the drilled hole, and the probe body supporting an optical illumination path and an optical signal sensing path. The plurality of instructions may include instructions that cause the computer system to determine a first set of attributes of the drilled hole at a first time period; instructions that cause the computer system to receive a second set of attributes of the drilled hole at a second time period; and instructions that cause the computer system to compare the first set of attributes with the second set of attributes to identify one or more changes that have occurred to the drilled hole between the first and second time periods. The computer-readable memory may further store other instructions that cause the computer system to carry out any of the steps described herein.

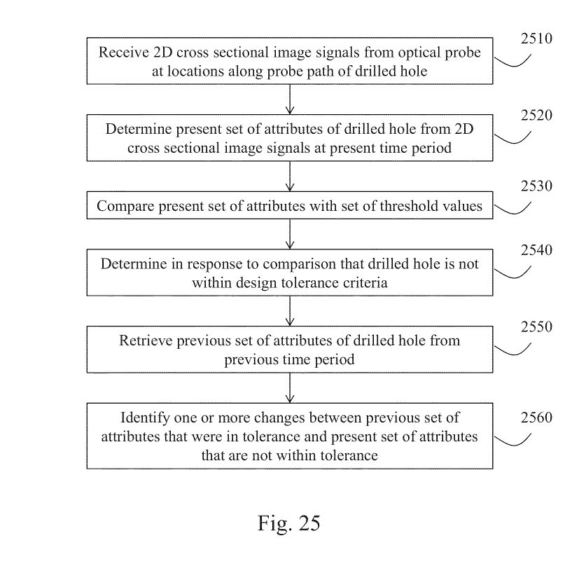

FIG. 25 illustrates a method for inspecting a drilled hole. The method includes receiving two-dimensional cross sectional image signals from an optical sensor of an optical probe at associated locations of a probe body of the optical probe along a probe path, the probe path extending into a drilled hole in a structure (block 2410). A present set of attributes of the drilled hole is determined from the two-dimensional cross sectional image signals at a present time period (block 2420). The present set of attributes is compared with a set of threshold values (block 2430). It is determined in response to the comparison that the drilled hole is not within design tolerance criteria (block 2440). A previous set of attributes of the drilled hole from a previous time period is retrieved (block 2450), and one more changes between the previous set of attributes that were in tolerance and the present set of attributes that are not within tolerance are identified (block 2460).

Based on the comparison, it can be determined if the drilled hole should be re-drilled based on the comparison. Optionally, the identified one or more changes of the drilled hole is transmitted to a storage database. The storage database can be data mined to determine which changes will result in other drilled holes being out of tolerance in the future. The set of threshold values can be updated based on the determination. In certain embodiments, the present and previous set of attributes of the drilled hole is associated with hole identification data indicative of a hole location on the structure as described above.

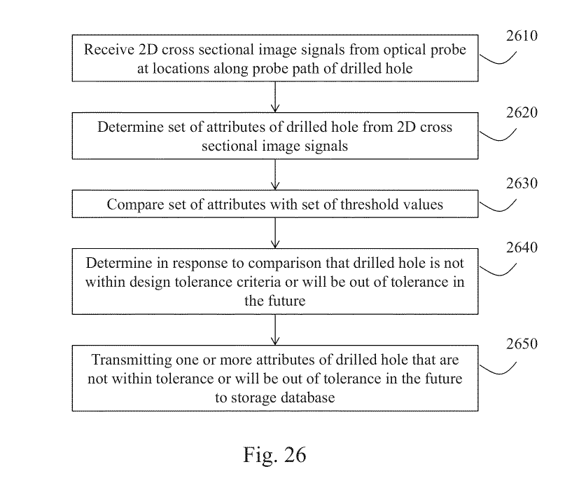

FIG. 26 illustrates a method for inspecting a drilled hole. The method includes receiving two-dimensional cross sectional image signals from an optical sensor of an optical probe at associated locations of a probe body of the optical probe along a probe path, the probe path extending into a drilled hole in a structure (block 2510). A set of attributes of the drilled hole is determined from the two-dimensional cross sectional image signals (block 2520). The set of attributes is compared with a set of threshold values at block (block 2530), and it is determined in response to the comparison that the drilled hole is not within design tolerance criteria or that the drilled hole will be out of tolerance in the future (block 2540). One or more attributes of the drilled hole that are not within tolerance or will be out of tolerance in the future are transmitted to a storage database (block 2550).

The method illustrated in FIG. 26 includes determining if the drilled hole should be re-drilled based on the comparison. Optionally, the method includes associating the set of attributes of the drilled hole with hole identification data indicative of a hole location on the structure. The method optionally includes updating the set of threshold values based on the determination. It will be further appreciated that the methods described above and illustrated in FIGS. 24-26 may be implemented with an optical probe according to any of the embodiments described herein.

While embodiments of the optical probe and methods described herein are substantially described with reference to their applicability in the aircraft and airline industries, embodiments of the optical probe and methods described herein may be applied in other industries, such as but not limited to the nuclear power plant, wind energy and automotive industries. Nuclear power plant reactor pressure vessels, for example, have drilled holes which must be manufactured within extremely tight tolerances, and it would be particularly useful to identify and profile attributes of these drilled holes during construction of the pressure vessel and following subsequent operation of the reactor plant.

It should be understood that the various methods described herein for measuring, profiling and otherwise evaluating drilled holes using an optical probes may be implemented by way of computer-readable instructions or other program code, which may have various different and alternative functional arrangements, processing flows, method steps, etc. Any suitable programming, scripting, or other type of language or combinations of languages may be used to implement the teachings contained herein in software to be used in programming or configuring a computing device.

Unless specifically stated otherwise, discussions in this specification utilizing terms such as “processing,” “computing,” “calculating,” “determining,” and “identifying” or the like refer to actions or processes of a computing device. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Numerous specific details are set forth herein to provide a thorough understanding of the subject matter of the various embodiments. However, those skilled in the art will understand that such subject matter may be practiced without some or all of these specific details. In other instances, methods, apparatuses, or systems that would be known by one of ordinary skill have not been described in detail so as not to obscure claimed subject matter.

Further, different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A system for measuring a drilled hole in a structure, the drilled hole having a drilled hole wall, the system comprising:
a probe having a probe body movable along a probe path extending into the drilled hole, the probe body supporting an optical illumination path and an optical signal sensing path;
the optical illumination path of the probe configured to direct illumination light along an illumination surface extending radially outwardly from the probe body so as to intersect the drilled hole wall when the probe body is disposed at a location along the probe path and the illumination light is transmitted along the illumination path, the intersection of the illumination surface and the drilled hole wall forming an optical section signal associated with the location of the probe along the probe path; and
the optical signal sensing path of the probe configured to transmit the optical section signal to an optical sensor.

2. The system of claim 1, further comprising a robot movably supporting the probe, the robot providing robotic signals indicative of the location of the probe along the probe path.

3. The system of claim 2, wherein the robot comprises a probe deployment system.

4. The system of claim 2, further comprising a processor coupled to the optical sensor and the robot, the processor configured to transmit attributes of the drilled hole in response to a plurality of optical section signals and associated locations of the probe.

5. The system of claim 4, wherein the drilled hole comprises a countersunk shape, and wherein the attributes transmitted by the processor are indicative of the countersunk shape.

6. The system of claim 2, further comprising the optical sensor, wherein the optical sensor is configured to generate two-dimensional hole section data when the probe is disposed adjacent the location and while the robot moves the probe continuously between first and second locations along the probe path.

7. The system of claim 1, wherein the probe forms a part of a hand-held system, and wherein the hand-held system is configured to associate attributes of the drilled hole determined from the optical section signal with hole identification data indicative of a hole location on the structure.

8. The system of claim 7, further comprising a tripod, clamp, adaptor plate, suction cup, or guide coupled to the hand-held system to align the probe relative to the drilled hole.

9. The system of claim 1, further comprising an optical illumination source coupled with the optical illumination path, the optical illumination source comprising at least one laser or light emitting diode.

10. The system of claim 9, wherein the probe body has a proximal end and a distal end, the distal end extendable into the drilled hole, and wherein the optical illumination source is coupled to the distal end of the probe body and the optical sensor is coupled to the proximal end of the probe body.

11. The system of claim 9, wherein the optical illumination source and optical sensor are coupled to a proximal end of the probe body.

12. The system of claim 9, wherein the optical illumination source is aligned with the probe body so as to direct the illumination light substantially parallel to a probe axis.

13. The system of claim 9, wherein the optical illumination source is aligned with the probe body so as to direct the illumination light substantially perpendicular or at an angle to a probe axis.

14. The system of claim 1, wherein the optical illumination path is configured to direct the illumination light along a continuous region of the illumination surface.

15. The system of claim 1, wherein the optical signal sensing path is defined in-part by a first optical element, the first optical element comprising a first conical surface configured to reflect the optical section signal from the intersection of the illumination surface and the drilled hole wall toward the optical sensor as a two-dimensional cross sectional image signal, and wherein the optical signal sensing path is configured to image a cross section of the drilled hole associated with the location of the probe along the probe path onto a sensor surface of the optical sensor.

16. The system of claim 15, wherein the optical illumination path is defined in-part by the first conical surface of the first optical element.

17. The system of claim 15, wherein the optical illumination path is defined in-part by a second conical surface offset from the first conical surface.

18. The system of claim 1, wherein the optical illumination path is defined in-part by a first optical element, the first optical element comprising a first conical surface.

19. The system of claim 1, wherein at least one of the optical illumination or signal sensing paths comprises a lens assembly including a plurality of lenses.

20. The system of claim 1, wherein the illumination surface comprises a planar sheet or a conical surface.

21. The system of claim 1, wherein the optical section signal is indicative of a two dimensional cross-sectional shape of the drilled hole transverse to the probe body and the probe body is smaller in cross-section than the drilled hole.

22. The system of claim 1, wherein the optical sensor comprises a detector, camera, or CCD.

23. The system of claim 1, further comprising at least one mask element coupled to the optical signal sensing path and configured to mitigate noise.

24. The system of claim 1, wherein the probe body further comprises an anti-reflective coating on a surface thereof configured to mitigate noise.

25. A system for measuring a drilled hole in a structure, the drilled hole having a drilled hole wall, the system comprising:
a probe having a probe body movable along a probe path extending into the drilled hole, the probe body supporting an optical illumination path and an optical signal sensing path;
the optical illumination path of the probe configured to direct illumination light radially outwardly from the probe body so as to intersect the drilled hole wall when the probe body is disposed at a location along the probe path and the illumination light is transmitted along the illumination path, the intersection forming an optical section signal associated with the location of the probe along the probe path; and
the optical signal sensing path of the probe configured to transmit the optical section signal to an optical sensor.

26. A method for using an optical scanning system for measuring a drilled hole in a structure, the drilled hole having a drilled hole wall, the method comprising:
transmitting a light signal along an optical illumination path of a probe moveable along a probe path extending into the drilled hole;
directing the illumination light signal radially outwardly from a body of the probe along an illumination surface that intersects the drilled hole wall to form a two-dimensional cross section signal associated with a location of the probe along the probe path; and
transmitting the two-dimensional cross section signal along an optical signal sensing path of the probe to an optical sensor so as to determine attributes of the drilled hole.

27. The method of claim 26, further comprising moving the probe continuously between first and second locations along the probe path and providing signals indicative of the location of the probe along the probe path.

28. The method of claim 26, further comprising processing the two-dimensional cross section signals and associated locations of the probe so as to determine attributes of the drilled hole.

29. The method of claim 26, further comprising associating attributes of the drilled hole with hole identification data indicative of a hole location on the structure.

30. The method of claim 26, wherein transmitting the two-dimensional cross section signal further comprises reflecting the two-dimensional cross section signal from the intersection of the illumination surface and the drilled hole wall toward the optical sensor.

31. The method of claim 30, further comprising imaging a cross section of the drilled hole associated with the location of the probe along the probe path onto a sensor surface of the optical probe.

32. The method of claim 26, further comprising mitigating noise.

33. The method of claim 26, further comprising aligning the probe along a probe axis that is parallel to a center axis of the drilled hole.

34. The method of claim 26, wherein transmitting the light further comprises transmitting a semi-collimated light signal.

35. An optical probe for measuring a drilled hole in a structure, the drilled hole having a drilled hole wall, the optical probe comprising:
a probe body movable along a probe path extending into the drilled hole, the probe body supporting an optical illumination path and an optical signal sensing path;
the optical illumination path of the probe configured to direct illumination light radially outwardly from the probe body so as to form an optical signal associated with a location of the probe along the probe path when the probe body is disposed at the location along the probe path and the illumination light is transmitted along the illumination path; and
the optical signal sensing path of the probe comprising in-part a first optical element disposed along the optical sensing path, the first optical element comprising a first conical surface configured to reflect the optical signal from the drilled hole wall to an optical sensor as a two dimensional image signal.

36. The optical probe of claim 35, wherein the optical signal sensing path is configured to image a cross section of the drilled hole associated with the location of the probe along the probe path onto a sensor surface of the optical sensor.

37. The optical probe of claim 35, wherein the optical illumination path is defined in-part by the first conical surface of the first optical element.

38. The optical probe of claim 35, wherein the optical illumination path is defined in-part by a second conical surface offset from the first conical surface.

39. The optical probe of claim 35, wherein the first optical element comprises a single conical mirror or a dual conical mirror.

40. The optical probe of claim 35, wherein the signal sensing path further comprises a lens assembly including a plurality of lenses.

41. The optical probe of claim 35, further comprising a robot movably supporting the probe, the robot providing robotic signals indicative of the location of the probe along the probe path.

42. The optical probe of claim 41, wherein the robot comprises a probe deployment system.

43. The optical probe of claim 41, further comprising a processor coupled to the optical sensor and the robot, the processor configured to transmit attributes of the drilled hole in response to a plurality of two-dimensional image signals and associated locations of the probe.

44. The optical probe of claim 43, wherein the drilled hole comprises a countersunk shape, and wherein the attributes transmitted by the processor are indicative of the countersunk shape.

45. The optical probe of claim 35, wherein the probe forms a part of a hand-held system, and wherein the hand-held system is configured to associate attributes of the drilled hole determined from the two-dimensional image signal with hole identification data indicative of a hole location on the structure.

46. The optical probe of claim 45, further comprising a tripod, clamp, adaptor plate, suction cup, or guide coupled to the hand-held system to align the probe relative to the drilled hole.

47. The optical probe of claim 35, further comprising an optical illumination source coupled with the optical illumination path, the optical illumination source comprising at least one laser or light emitting diode.

48. The optical probe of claim 47, wherein the probe body has a proximal end and a distal end, the distal end extendable into the drilled hole, and wherein the optical illumination source is coupled to the distal end of the probe body and the optical sensor is coupled to the proximal end of the probe body.

49. The optical probe of claim 47, wherein the optical illumination source and optical sensor are coupled to a proximal end of the probe body.

50. The optical probe of claim 47, wherein the optical illumination source is aligned with the probe body so as to direct the illumination light substantially parallel to a probe axis.

51. The optical probe of claim 47, wherein the optical illumination source is aligned with the probe body so as to direct the illumination light substantially perpendicular or at an angle to a probe axis.

52. The optical probe of claim 35, wherein the optical sensor comprises a detector, camera, or CCD.

53. The optical probe of claim 35, further comprising at least one mask element coupled to the optical signal sensing path and configured to mitigate noise.

54. The optical probe of claim 35, wherein the probe body further comprises an anti-reflective coating on a surface thereof configured to mitigate noise.

55. An optical probe for measuring a drilled hole in a structure, the drilled hole having a drilled hole wall, the system comprising:
a probe body movable along a probe path extending into the drilled hole, the probe body supporting an optical illumination path and an optical signal sensing path;
the optical illumination path of the probe comprising an optical illumination source disposed along the optical illumination path and offset from a probe axis, the optical illumination source configured to direct illumination light at an angle to the probe axis, the optical illumination path configured to direct the illumination light from the angle and along an illumination surface extending radially outwardly from the probe body so as to intersect the drilled hole wall when the probe body is disposed at a location along the probe path and the illumination light is transmitted along the illumination path, the intersection of the illumination surface and the drilled hole wall forming an optical section signal associated with the location of the probe along the probe path; and
the optical signal sensing path of the probe configured to transmit the optical section signal to an optical sensor.

56. The optical probe of claim 55, wherein the optical illumination source comprises a laser or light emitting diode.

57. The optical probe of claim 55, wherein the optical illumination source and optical sensor is coupled to the proximal end of the body.

58. The optical probe of claim 55, wherein the optical illumination path is defined by a first optical element, the first optical element comprising a first conical surface.

59. The optical probe of claim 58, wherein the first optical element comprises a single conical mirror.

60. The optical probe of claim 55, wherein the signal sensing path further comprises a lens assembly including a plurality of lenses.

61. An optical probe for measuring a drilled hole in a structure, the drilled hole having a drilled hole wall, the optical probe comprising:
a probe body movable along a probe path extending into the drilled hole, the probe body supporting an optical illumination path and an optical signal sensing path;
the optical illumination path of the probe comprising an optical illumination source and a first optical element comprising a first conical surface configured to direct illumination light radially outwardly from the probe body so as to intersect the drilled hole wall when the probe body is disposed at a location along the probe path and the illumination light is transmitted along the illumination path, the intersection forming an optical section signal associated with the location of the probe along the probe path; and
the optical signal sensing path of the probe configured to transmit the optical section signal to an optical sensor.

62. The optical probe of claim 61, wherein the first optical element comprises a single conical mirror.

63. The optical probe of claim 61, wherein the optical illumination source comprises a laser.

64. The optical probe of claim 61, wherein the probe body has a proximal end and a distal end, the distal end extendable into the drilled hole, and wherein the optical illumination source is coupled to the distal end of the probe body and the optical sensor is coupled to the proximal end of the probe body.

65. The optical probe of claim 64, further comprising at least one heat sink coupled to the distal end of the probe body.

66. The optical probe of claim 65, wherein the at least one heat sink comprises a metal ring.

67. The optical probe of claim 61, wherein the optical illumination source is aligned with the probe body so as to direct the illumination light substantially parallel to a probe axis.

68. A method for identifying damage of a drill, the method comprising:
receiving two-dimensional cross sectional image signals from an optical sensor of an optical probe at associated locations of a probe body of the optical probe along a probe path, the probe path extending into a drilled hole in a structure, the drilled hole having a drilled hole wall;
determining a set of attributes of the drilled hole from the two-dimensional cross sectional image signals;
comparing the set of attributes to a damaged drill profile; and
identifying if the drill is damaged based on the comparison of the set of attributes to the damaged drill profile.

69. The method of claim 68, further comprising:
receiving a second set of two-dimensional cross sectional image signals from the optical sensor at associated locations of the probe body along the probe path extending into a second drilled hole;
determining a second set of attributes of the second drilled hole from the second set of two dimensional cross sectional image signals;
comparing the set of attributes of the drilled hole with the second set of attributes of the second drilled hole; and
identifying if the drill is damaged based on the comparison between the set of attributes of the drilled hole with the second set of attributes of the second drilled hole.

70. The method of claim 69, wherein comparing the set of attributes of the drilled hole with the second set of attributes of the second drilled hole further comprises:
detecting one or more differences between the set of attributes of the drilled hole with the second set of attributes of the second drilled hole; and
comparing the one or more detected differences to the damaged drill profile.

71. The method of claim 70, wherein identifying if the drill is damaged based on the comparison between the set of attributes of the drilled hole with the second set of attributes of the second drilled hole further comprises determining from the comparison of the one more detected differences to the damaged drill profile if the drill is damaged.

72. The method of claim 68, further comprising:
determining multiple sets of attributes of multiple drilled holes;
comparing multiple sets of attributes of multiple drilled holes between each other to detect one or more differences;
comparing the one or more detected differences to the damaged drill profile; and
identifying from the comparison of the one more detected differences to the damaged drill profile if the drill is damaged.

73. The method of claim 68, further comprising repeating the receiving, determining, comparing, and identifying steps with respect to multiple drilled holes.

74. The method of claim 68, further comprising providing an audio or visual alert if the damaged drill is identified.

75. The method of claim 74, further comprising determining if the drilled hole should be re-drilled based on the identified damaged drill.

76. The method of claim 68, further comprising transmitting the set of attributes of the drilled hole to a storage database.

77. The method of claim 68, wherein the set of attributes comprises circularity, elongation, smoothness, roughness, tapering, depth, or angularity.

78. The method of claim 68, further comprising:
transmitting a light signal with the optical probe along an optical illumination path of the probe body moveable along the probe path extending into the drilled hole;
directing the illumination light signal with the optical probe radially outwardly from the probe body along an illumination surface that intersects the drilled hole wall to form a two-dimensional cross section signal associated with a location of the probe along the probe path; and
transmitting the two-dimensional cross section signal with the optical probe along an optical signal sensing path of the probe to the optical sensor.

79. The method of claim 78, further comprising moving the probe continuously between first and second locations along the probe path and providing signals indicative of the location of the probe along the probe path.

80. The method of claim 68, further comprising associating the set of attributes of the drilled hole with hole identification data indicative of a hole location on the structure.

81. The method of claim 68, wherein identifying if the drill is damaged further comprises identifying a damaged drill bit or misaligned drill.

82. A computer-readable memory storing a plurality of instructions for controlling a computer system to identify a damaged drill tip, the computer system configured for use with an optical probe for measuring a drilled hole in a structure, the drilled hole having a drilled hole wall, the optical probe having a probe body movable along a probe path extending into the drilled hole, the probe body supporting an optical illumination path and an optical signal sensing path, the plurality of instructions comprising:
instructions that cause the computer system to determine a first set of attributes of a first drilled hole;
instructions that cause the computer system to determine a second set of attributes of a second drilled hole;
instructions that cause the computer system to compare the first set of attributes of the first drilled hole with the second set of attributes of the second drilled hole to detect one or more differences;
instructions that cause the computer system to compare the one or more detected differences to a damaged tip profile; and
instructions that cause the computer system to identify if a drill tip is damaged based on the comparison of the one or more detected differences to the damaged tip profile.

83. The computer-readable memory according to claim 82 further comprising instructions that cause the computer system to provide an audio or visual alert if the damaged drill tip is identified.

84. A method for profiling a drilled hole over a period of time, the method comprising:
receiving two-dimensional cross sectional image signals from an optical sensor of an optical probe at associated locations of a probe body of the optical probe along a probe path, the probe path extending into a drilled hole in a structure;
determining a first set of attributes of the drilled hole from the two-dimensional cross sectional image signals at a first time period;
receiving a second set of attributes of the drilled hole at a second time period; and
comparing the first set of attributes with the second set of attributes to identify one or more changes that have occurred to the drilled hole between the first and second time periods.

85. The method of claim 84, further comprising determining if the identified one or more changes leads to the drilled hole being out of tolerance in the future.

86. The method of claim 85, further comprising comparing the identified one or more changes to a database of other drilled hole profiles that have become out of tolerance over time.

87. The method of claim 84, wherein comparing comprises determining one more changes between the first set of attributes that were in tolerance and the second set of attributes that are not within tolerance.

88. The method of claim 87, further comprising updating threshold values associated with design tolerance criteria based on the determination.

89. The method of claim 88, further comprising transmitting the first and second set of attributes of the drilled hole to a storage database.

90. The method of claim 84, further comprising associating the first and second set of attributes of the drilled hole with hole identification data indicative of a hole location on the structure.

91. The method of claim 84, wherein the first or second set of attributes comprises circularity, elongation, smoothness, roughness, tapering, depth, or angularity.

92. The method of claim 84, further comprising identifying a burr, crack, pit, or other drilled hole defect.

93. The method of claim 84, wherein the method further comprises:
transmitting a light signal with the optical probe along the optical illumination path of the probe body moveable along the probe path extending into the drilled hole;
directing the illumination light signal with the optical probe radially outwardly from the probe body along an illumination surface that intersects the drilled hole wall to form a two-dimensional cross section signal associated with a location of the probe along the probe path; and
transmitting the two-dimensional cross section signal with the optical probe along the optical signal sensing path of the probe to the optical sensor.

94. The method of claim 93, further comprising moving the probe continuously between first and second locations along the probe path and providing signals indicative of the location of the probe along the probe path.

95. A computer-readable memory storing a plurality of instructions for controlling a computer system to identify a profile for a drilled hole, the computer system configured for use with an optical probe for measuring a drilled hole in a structure, the drilled hole having a drilled hole wall, the optical probe having a probe body movable along a probe path extending into the drilled hole, the probe body supporting an optical illumination path and an optical signal sensing path, the plurality of instructions comprising:
instructions that cause the computer system to determine a first set of attributes of the drilled hole at a first time period;
instructions that cause the computer system to receive a second set of attributes of the drilled hole at a second time period; and
instructions that cause the computer system to compare the first set of attributes with the second set of attributes to identify one or more changes that have occurred to the drilled hole between the first and second time periods.

96. A method for inspecting a drilled hole, the method comprising:
receiving two-dimensional cross sectional image signals from an optical sensor of an optical probe at associated locations of a probe body of the optical probe along a probe path, the probe path extending into a drilled hole in a structure;
determining a present set of attributes of the drilled hole from the two-dimensional cross sectional image signals at a present time period;
comparing the present set of attributes with a set of threshold values;
determining in response to the comparison that the drilled hole is not within design tolerance criteria;
retrieving a previous set of attributes of the drilled hole from a previous time period; and
identifying one more changes between the previous set of attributes that were in tolerance and the present set of attributes that are not within tolerance.

97. The method of claim 96, further comprising determining if the drilled hole should be re-drilled based on the comparison.

98. The method of claim 96, further comprising transmitting the identified one or more changes of the drilled hole to a storage database.

99. The method of claim 98, further comprising data mining the storage database to determine which changes will result in other drilled holes being out of tolerance in the future.

100. The method of claim 99, further comprising updating the set of threshold values based on the determination.

101. The method of claim 96, further comprising associating the present and previous set of attributes of the drilled hole with hole identification data indicative of a hole location on the structure.

102. A method for inspecting a drilled hole with a processor, the method comprising:
receiving two-dimensional cross sectional image signals from an optical sensor of an optical probe at associated locations of a probe body of the optical probe along a probe path, the probe path extending into a drilled hole in a structure;
determining a set of attributes of the drilled hole from the two-dimensional cross sectional image signals;
comparing the set of attributes with a set of threshold values;
determining in response to the comparison that the drilled hole is not within design tolerance criteria or that the drilled hole will be out of tolerance in the future; and
transmitting one or more attributes of the drilled hole that are not within tolerance or will be out of tolerance in the future to a storage database.

103. The method of claim 102, further comprising determining if the drilled hole should be re-drilled based on the comparison.

104. The method of claim 102, further comprising associating the set of attributes of the drilled hole with hole identification data indicative of a hole location on the structure.

105. The method of claim 102, further comprising updating the set of threshold values based on the determination.

106. An optical scanning system for measuring a drilled hole in a structure, the drilled hole having a drilled hole wall, the system comprising:
an end effector;
a drilling apparatus coupled to the end effector and configured to drill a hole in the structure;
an optical probe having a probe body moveable along a probe path, the probe path extending into the drilled hole; and
an optical probe deployment system coupled to the end effector and the optical probe and configured to move the probe body continuously between first and second locations along the probe path while the optical probe scans the drilled hole.

107. The system of claim 106, wherein the optical probe deployment system comprises a piezoelectric motor configured to move the probe body continuously between first and second locations along the probe path extending inside the drilled hole.

108. The system of claim 106, wherein the optical probe deployment system comprises an actuator configured to move the optical probe from a home position to a deployed position over the drilled hole.

109. The system of claim 106, wherein the end effector further comprises a pressure foot having a drill passageway, wherein the optical probe deployment system comprises an arm configured to move the optical probe from a home position outside the pressure foot to a deployed position within the pressure foot.

110. The system of claim 109, wherein the optical probe is coupled to the arm by a flexible mount.

111. The system of claim 109, wherein the probe deployment system further comprises shock absorbers and limit switches.

112. The system of claim 106, further comprising a robotic transport configured to move the end effector.

113. The system of claim 112, wherein the end effector further comprises a control box configured to control the optical probe deployment system, to process optical probe data, and to communicate the processed data with the robotic transport.

114. The system of claim 106, wherein the optical probe further comprises:
an optical illumination path supported by the probe body and configured to direct illumination light along an illumination surface extending radially outwardly from the probe body so as to intersect the drilled hole wall when the probe body is disposed at a location along the probe path and the illumination light is transmitted along the illumination path, the intersection of the illumination surface and the drilled hole wall forming an optical section signal associated with the location of the probe along the probe path; and
the optical signal sensing path supported by the probe body and configured to transmit the optical section signal to an optical sensor.

115. A drilled hole scanning apparatus comprising:
an optical probe having a probe body moveable along a probe path, the probe path extending into a drilled hole in a structure; and
an optical probe deployment system comprising:
an actuator configured to move the optical probe from a home position to a deployed position over the drilled hole; and
a piezoelectric motor configured to continuously move the probe body continuously between first and second locations along the probe path while the optical probe scans the drilled hole.

116. The apparatus of claim 115, further comprising an arm coupled to the actuator and configured to swing the optical probe from the home position outside a pressure foot to the deployed position within the pressure foot.

117. The apparatus of claim 116, wherein the optical probe is coupled to the arm by a flexible mount.

118. The apparatus of claim 115, further comprising a control box configured to control the actuator and piezoelectric motor, process optical probe data, and determine whether the drilled hole is within a predetermined tolerance.

119. A method for deploying an optical scanning system comprising:
drilling a hole in a structure;
moving an optical probe continuously between first and second locations along a probe path extending into the drilled hole; and
scanning the drilled hole with the optical probe while the optical probe is continuously moved.

120. The method of claim 119, wherein moving the optical probe comprises positioning the optical probe from a home position to a deployed position over the drilled hole.

121. The method of claim 120, further comprising swinging the optical probe from the home position outside a pressure foot to the deployed position within the pressure foot.

122. The method of claim 119, further comprising determining whether the drilled hole is within a predetermined tolerance.

123. The method of claim 122, wherein determining comprises processing optical probe data.

124. The method of claim 119, further comprising positioning the optical scanning system with a robotic transport.

125. The method of claim 119, wherein scanning further comprises:
transmitting a light signal along an optical illumination path of the optical probe as it is moved along the probe path;
directing the illumination light signal radially outwardly from a body of the probe along an illumination surface that intersects a drilled hole wall to form a two-dimensional cross section signal associated with a location of the probe along the probe path; and
transmitting the two-dimensional cross section signal along an optical signal sensing path of the probe to an optical sensor so as to determine attributes of the drilled hole.
